(19) United States
(12) Patent Application Publication
(10) Pub. No.: US 2024/0277068 A1
(43) Pub. Date: Aug. 22, 2024

(54) HEATER ASSEMBLY FOR AEROSOL GENERATING DEVICE AND AEROSOL GENERATING DEVICE INCLUDING THE SAME

(71) Applicant: KT&G CORPORATION, Daejeon (KR)

(72) Inventors: Dong Sung KIM, Seoul (KR); Young Bum KWON, Yongin-si (KR); Yong Hwan KIM, Anyang-si (KR); Hun Il LIM, Seoul (KR)

(73) Assignee: KT&G CORPORATION, Daejeon (KR)

(21) Appl. No.: 18/402,932

(22) Filed: Jan. 3, 2024

(30) Foreign Application Priority Data
Feb. 22, 2023 (KR) 10-2023-0023646
May 3, 2023 (KR) 10-2023-0057765

(51) Int. Cl. A24F 40/51; A24F 40/20; A24F 40/465; A24F 40/48; A24F 40/53; H05B 6/10

(52) U.S. Cl. CPC A24F 40/51; A24F 40/20; A24F 40/465; A24F 40/48; A24F 40/53; H05B 6/105; A24F 40/10; A24F 40/30

(57) ABSTRACT

A heater assembly for an aerosol generating device includes a body including a receiving space in which an aerosol generating article is accommodated, a coil configured to apply a magnetic field so that a susceptor located in the receiving space generates heat to heat the aerosol generating article, an air flow passage cover located outside the body and including an air flow passage through which air passes, a pressure sensor located on the air flow passage cover and configured to detect a change in pressure inside the air flow passage, and a moisture detecting sensor located on a support unit for supporting the coil and configured to detect moisture in the aerosol generating article accommodated in the receiving space.

### CROSS-REFERENCE TO RELATED APPLICATION

This application is based on and claims priority under 35 U.S.C. § 119 to Korean Patent Application Nos. 10-2023-0023646 and 10-2023-0057765, respectively filed on Feb. 22, 2023 and May 3, 2023, in the Korean Intellectual Property Office, the disclosures of which are incorporated by reference herein in their entirety.

### BACKGROUND

### 1. Field

Embodiments relate to a heater assembly for an aerosol generating device, which may improve space utilization for the arrangement of components such as a sensor for detecting moisture in an aerosol generating article and may allow an air flow to move smoothly, and an aerosol generating device including the heater assembly.

### 2. Description of the Related Art

Recently, the demand for alternative methods of providing aerosols by burning general cigarettes has increased. For example, research has been conducted on methods that provide aerosols with flavors by generating aerosols from a liquid or solid aerosol generating material, generating vapor from the liquid aerosol generating material, and then allowing the generated vapor to pass through a solid flavor medium.

An example of an aerosol generating device may include an aerosol generating device using an induction heat method which heats an aerosol generating material by generating a magnetic field so that a susceptor generates heat.

### SUMMARY

An aerosol generating device using an induction heating method may include a sensor for detecting moisture in an aerosol generating article, a sensor for detecting a type of the aerosol generating article, and a sensor for detecting a change in pressure inside an air flow passage through which air passes.

In order to arrange these sensors inside the aerosol generating device, a specific space should be secured in advance, and in order to improve space utilization inside the aerosol generating device while ensuring an optimal function of each of the sensors, it is necessary to locate (mount) each sensor at an appropriate position.

Also, in order for a user to inhale aerosol through the aerosol generating article, external air should be introduced into the aerosol generating device. To this end, the aerosol generating device may include an air flow passage through which air moves. When air does not move smoothly in the air flow passage, the user is not able to easily inhale aerosol through the aerosol generating article.

An objective of the disclosure is to provide a heater assembly for an aerosol generating device which may improve space utilization for the arrangement of components such as a sensor in the aerosol generating device, and an aerosol generating device including the heater assembly.

Also, an objective of the disclosure is to provide a heater assembly for an aerosol generating device which has a compact structure while accommodating various components therein, and an aerosol generating device including the heater assembly.

Also, an objective of the disclosure is to provide a heater assembly for an aerosol generating device which has a structure that facilitates the flow of air in an air flow passage so that a user easily inhales aerosol, and an aerosol generating device including the heater assembly.

The technical problems of the present disclosure are not limited to the aforementioned description, and other technical problems may be clearly understood by one of ordinary skill in the art from the present specification and the attached drawings.

Additional aspects will be set forth in part in the description which follows and, in part, will be apparent from the description, or may be learned by practice of the presented embodiments.

According to an embodiment, a heater assembly for an aerosol generating device includes a body including a receiving space in which an aerosol generating article is accommodated, a coil configured to apply a magnetic field so that a susceptor located in the receiving space generates heat to heat the aerosol generating article, an air flow passage cover located outside the body and including an air flow passage through which air passes, a pressure sensor located on the air flow passage cover and configured to detect a change in pressure inside the air flow passage, and a moisture detecting sensor located on a support unit for supporting the coil and configured to detect moisture in the aerosol generating article accommodated in the receiving space.

According to an embodiment, an aerosol generating device includes the heater assembly for an aerosol generating device, a battery configured to supply power to the heater assembly for an aerosol generating device, and a controller configured to control an operation of the heater assembly for an aerosol generating device.

### BRIEF DESCRIPTION OF THE DRAWINGS

The above and other aspects, features, and advantages of certain embodiments will be more apparent from the following description taken in conjunction with the accompanying drawings, in which:

FIG. 1 is a perspective view illustrating an aerosol generating device and an aerosol generating article inserted into the aerosol generating device, according to an embodiment;

FIG. 2 is a front perspective view illustrating a heater assembly for an aerosol generating device, according to an embodiment;

FIG. 3 is a rear perspective view illustrating a heater assembly for an aerosol generating device, according to an embodiment;

FIG. 4 is an exploded perspective view illustrating the heater assembly for an aerosol generating device according to the embodiment of FIG. 2;

FIG. 5 is a cross-sectional view illustrating the heater assembly for an aerosol generating device according to an embodiment taken along line I-I′ of FIG. 2, showing a state where an aerosol generating article is inserted into the heater assembly;

FIG. 6 is a cross-sectional view illustrating the heater assembly for an aerosol generating device according to an embodiment taken along line II-II′ of FIG. 2, showing a state where an aerosol generating article is inserted into the heater assembly;

FIG. 7 is an exploded perspective view illustrating a holder, a first cover, a temperature detecting unit, and a shielding unit included in a heater assembly for an aerosol generating device, according to an embodiment;

FIG. 8 is an exploded perspective illustrating a first cover, an air flow passage cover, and a mount member included in a heater assembly for an aerosol generating device, according to an embodiment;

FIG. 9 is a rear perspective view illustrating a heater assembly for an aerosol generating device, according to an embodiment, showing a coupling relationship between a sealing portion, a second cover, an air flow passage cover, and a support unit;

FIG. 10 is a combined perspective view illustrating a support unit, a heater, an accommodation detecting unit, and a temperature detecting unit included in a heater assembly for an aerosol generating device, according to an embodiment;

FIGS. 11 and 12 illustrate examples of an aerosol generating article according to an embodiment; and

FIG. 13 is a block diagram of an aerosol generating device according to another embodiment.

### DETAILED DESCRIPTION

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, when an expression such as “at least any one” precedes arranged elements, it modifies all elements rather than each arranged element. For example, the expression “at least any one of a, b, and c” should be construed to include a, b, c, or a and b, a and c, b and c, or a, b, and c.

In an embodiment, an aerosol generating device may be a device that generates aerosols by electrically heating a cigarette accommodated in an interior space thereof.

The aerosol generating device may include a heater. In an embodiment, the heater may be an electro-resistive heater. For example, the heater may include an electrically conductive track, and the heater may be heated when currents flow through the electrically conductive track.

The heater may include a tube-shaped heating element, a plate-shaped heating element, a needle-shaped heating element, or a rod-shaped heating element, and may heat the inside or outside of a cigarette according to the shape of a heating element.

A cigarette may include a tobacco rod and a filter rod. The tobacco rod may be formed of sheets, strands, and tiny bits cut from a tobacco sheet. Also, the tobacco rod may be surrounded by a heat conductive material. For example, the heat conductive material may be, but is not limited to, a metal foil such as aluminum foil.

The filter rod may include a cellulose acetate filter. The filter rod may include at least one segment. For example, the filter rod may include a first segment configured to cool aerosols, and a second segment configured to filter a certain component in aerosols.

In another embodiment, the aerosol generating device may be a device that generates aerosols by using a cartridge containing an aerosol generating material.

The aerosol generating device may include a cartridge that contains an aerosol generating material, and a main body that supports the cartridge. The cartridge may be detachably coupled to the main body, but is not limited thereto. The cartridge may be integrally formed or assembled with the main body, and may also be fixed to the main body so as not to be detached from the main body by a user. The cartridge may be mounted on the main body while accommodating an aerosol generating material therein. However, the present disclosure is not limited thereto. An aerosol generating material may also be injected into the cartridge while the cartridge is coupled to the main body.

The cartridge may contain an aerosol generating material in any one of various states, such as a liquid state, a solid state, a gaseous state, a gel state, or the like. The aerosol generating material may include a liquid composition. For example, the liquid composition may be a liquid including a tobacco-containing material having a volatile tobacco flavor component, or a liquid including a non-tobacco material.

The cartridge may be operated by an electrical signal or a wireless signal transmitted from the main body to perform a function of generating aerosols by converting the phase of an aerosol generating material inside the cartridge into a gaseous phase. The aerosols may refer to a gas in which vaporized particles generated from an aerosol generating material are mixed with air.

In another embodiment, the aerosol generating device may generate aerosols by heating a liquid composition, and generated aerosols may be delivered to a user through a cigarette. That is, the aerosols generated from the liquid composition may move along an airflow passage of the aerosol generating device, and the airflow passage may be configured to allow aerosols to be delivered to a user by passing through a cigarette.

In another embodiment, the aerosol generating device may be a device that generates aerosols from an aerosol generating material by using an ultrasonic vibration method. At this time, the ultrasonic vibration method may mean a method of generating aerosols by converting an aerosol generating material into aerosols with ultrasonic vibration generated by a vibrator.

The aerosol generating device may include a vibrator, and generate a short-period vibration through the vibrator to convert an aerosol generating material into aerosols. The vibration generated by the vibrator may be ultrasonic vibration, and the frequency band of the ultrasonic vibration may be in a frequency band of about 100 kHz to about 3.5 MHz, but is not limited thereto.

The aerosol generating device may further include a wick that absorbs an aerosol generating material. For example, the wick may be arranged to surround at least one area of the vibrator, or may be arranged to contact at least one area of the vibrator.

As a voltage (for example, an alternating voltage) is applied to the vibrator, heat and/or ultrasonic vibrations may be generated from the vibrator, and the heat and/or ultrasonic vibrations generated from the vibrator may be transmitted to the aerosol generating material absorbed in the wick. The aerosol generating material absorbed in the wick may be converted into a gaseous phase by heat and/or ultrasonic vibrations transmitted from the vibrator, and as a result, aerosols may be generated.

For example, the viscosity of the aerosol generating material absorbed in the wick may be lowered by the heat generated by the vibrator, and as the aerosol generating material having a lowered viscosity is granulated by the ultrasonic vibrations generated from the vibrator, aerosols may be generated, but is not limited thereto.

In another embodiment, the aerosol generating device is a device that generates aerosols by heating an aerosol generating article accommodated in the aerosol generating device in an induction heating method.

The aerosol generating device may include a susceptor and a coil. In an embodiment, the coil may apply a magnetic field to the susceptor. As power is supplied to the coil from the aerosol generating device, a magnetic field may be formed inside the coil. In an embodiment, the suspector may be a magnetic body that generates heat by an external magnetic field. As the suspector is positioned inside the coil and a magnetic field is applied to the suspector, the suspector generates heat to heat an aerosol generating article. In addition, optionally, the suspector may be positioned within the aerosol generating article.

In another embodiment, the aerosol generating device may further include a cradle.

The aerosol generating device may configure a system together with a separate cradle. For example, the cradle may charge a battery of the aerosol generating device. Alternatively, the heater may be heated when the cradle and the aerosol generating device are coupled to each other.

Hereinafter, the present disclosure will now be described more fully with reference to the accompanying drawings, in which exemplary embodiments of the present disclosure are shown such that one of ordinary skill in the art may easily work the present disclosure. The present disclosure may be implemented in a form that can be implemented in the aerosol generating devices of the various embodiments described above or may be implemented in various different forms, and is not limited to the embodiments described herein.

Hereinafter, embodiments of the present disclosure will be described in detail with reference to the drawings.

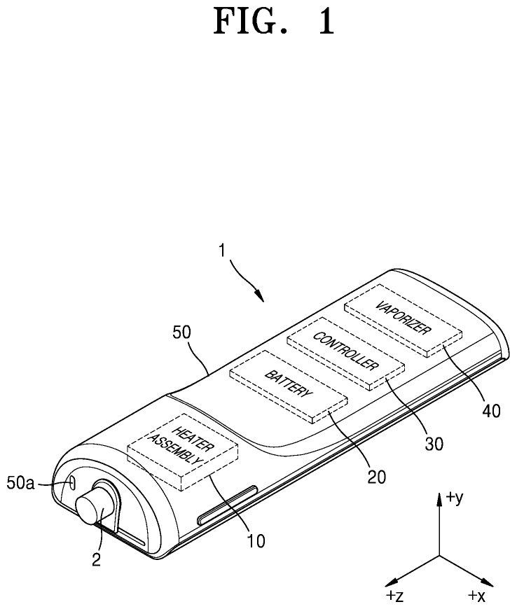

FIG. 1 is a perspective view illustrating an aerosol generating device and an aerosol generating article inserted into the aerosol generating device, according to an embodiment.

Referring to FIG. 1, an aerosol generating device 1 according to an embodiment may include a heater assembly 10, a battery 20, a controller 30, a vaporizer 40, and an aerosol generating device body 50. However, elements of the aerosol generating device 1 are not limited thereto, and according to an embodiment, at least one element (e.g., the vaporizer 40) from among the above elements may be omitted or other elements may be added.

The aerosol generating device 1 according to an embodiment may generate aerosol by heating an aerosol generating article 2 accommodated in the aerosol generating device 1 by using an induction heating method. An induction heating method may refer to a method of generating heat from a magnetic body by applying an alternating magnetic field whose direction is periodically changed to the magnetic body that generates heat due to an external magnetic field.

When an alternating magnetic field is applied to a magnetic body, energy loss due to eddy current loss and hysteresis loss may occur in the magnetic body, and the lost energy may be released from the magnetic body as thermal energy. As an amplitude or a frequency of an alternating magnetic field applied to a magnetic body increases, more thermal energy may be released from the magnetic body. The aerosol generating device 1 according to an embodiment may release thermal energy from a magnetic body by applying an alternating magnetic field to the magnetic body, and may transfer the thermal energy released from the magnetic body to an aerosol generating article.

The magnetic body that generates heat by an external magnetic field may be a susceptor.

According to an embodiment, a susceptor may be located inside the heater assembly 10 and may surround the aerosol generating article 2 accommodated in a receiving space. In this case, the susceptor may have a hollow cylindrical shape, but a shape is not limited thereto.

According to another embodiment, the susceptor may be located inside the aerosol generating article 2 accommodated in the aerosol generating device 1. In this case, the susceptor may be included as pieces, flakes, or strips in the aerosol generating article 2.

At least a part of the susceptor may be formed of a ferromagnetic substance. For example, the susceptor may include a metal or carbon. The susceptor may include at least one of ferrite, a ferromagnetic alloy, stainless steel, and aluminum (Al). Also, the susceptor may include at least one of a ceramic such as graphite, molybdenum, silicon carbide, niobium, nickel alloy, metal film, or zirconia, a transition metal such as nickel (Ni) or cobalt (Co), and a metalloid such as boron (B) or phosphorus (P).

The aerosol generating device 1 according to an embodiment may accommodate the aerosol generating article 2 therein. A space for accommodating the aerosol generating article 2 may be formed in the aerosol generating device 1 according to an embodiment. A heater assembly 10 for an aerosol generating device (hereinafter, referred to as “heater assembly”) according to an embodiment may be located in the space of the aerosol generating device 1 for accommodating the aerosol generating article 2. For example, the heater assembly 10 may include a cylindrical receiving space for accommodating the aerosol generating article 2 therein. Accordingly, when the aerosol generating article 2 is accommodated in the aerosol generating device 1, the aerosol generating article 2 may be accommodated in the receiving space of the heater assembly 10. The aerosol generating article 2 accommodated in the aerosol generating device 1 according to an embodiment will be described below in detail.

The heater assembly 10 according to an embodiment may heat the aerosol generating article 2 accommodated in the aerosol generating device 1. As described above, the heater assembly 10 according to an embodiment may heat the aerosol generating article 2 by using an induction heating method. According to an embodiment, the heater assembly 10 may generate heat from the susceptor by applying an alternating magnetic field to the susceptor.

The heater assembly 10 according to an embodiment may surround at least a part of the aerosol generating article 2 accommodated in the aerosol generating device 1. For example, the heater assembly 10 according to an embodiment may surround a tobacco medium included in the aerosol generating article 2. Accordingly, heat may be more efficiently transferred from the heater assembly 10 to the tobacco medium.

The battery 20 may supply power to the aerosol generating device 1. For example, the battery 20 may supply power to a coil (or referred to as a “heater”) of the heater assembly 10. In another example, the battery 20 may supply power required to operate other elements (e.g., the controller 30) of the aerosol generating device 1.

The battery 20 may include a battery unit that supplies direct current to the coil of the heater assembly 10 and a converter that converts the direct current supplied from the battery unit to alternating current supplied to the coil of the heater assembly 10.

The battery unit may supply direct current to the aerosol generating device 1. The battery unit may be, but is not limited to, a lithium iron phosphate (LiFePO4) battery. For example, the battery unit may be a lithium cobalt oxide (LiCoO2) battery, a lithium titanate battery, or a lithium polymer (LiPoly) battery.

The converter may include a low-pass filter that filters direct current supplied from the battery and outputs alternating current supplied to the heater assembly 10. The converter may further include an amplifier for amplifying direct current supplied from the battery unit. For example, the converter may be implemented through a low-pass filter that constitutes a load network of a class-D amplifier.

The controller 30 may control an overall operation of the aerosol generating device 1. The controller 30 may be implemented as an array of logic gates or may be implemented as a combination of a general-purpose microprocessor and a memory in which a program executable by the microprocessor is stored, but the disclosure is not limited thereto.

According to an embodiment, the controller 30 may control power supplied to the heater assembly 10. A control target of the controller 30 may be the coil of the heater assembly 10. The controller 30 may control the battery 20 so that power supplied to the coil of the heater assembly 10 is adjusted. For example, the controller 30 may perform control to maintain a constant temperature at which the coil heats the aerosol generating article 2 based on a temperature of the coil of the heater assembly 10.

The vaporizer 14 may generate aerosol by heating a liquid aerosol generating material, and the generated aerosol may pass through the aerosol generating article 2 and may be delivered to a user. In other words, the aerosol generated via the vaporizer 40 may move along an air flow passage of the aerosol generating device 1, and the air flow passage may be configured so that the aerosol generated by the vaporizer 40 passes through the aerosol generating article 2 and is delivered to the user.

For example, the vaporizer 40 may include, but is not limited to, a storage in which a liquid aerosol generating material is stored, a liquid delivery element, and a heating element. For example, the storage, the liquid delivery element, and the heating element may be included in the aerosol generating device 1 as independent modules.

The storage may store a liquid aerosol generating material. For example, the liquid aerosol generating material may be a liquid including a tobacco-containing material having a volatile tobacco flavor component, or a liquid including a non-tobacco material. The storage may be formed to be attachable/detachable to/from the vaporizer 40, or may be integrally formed with the vaporizer 40.

For example, the aerosol generating material may include water, solvents, ethanol, plant extracts, spices, flavorings, or vitamin mixtures. The spices may include menthol, peppermint, spearmint oil, and various fruit-flavored ingredients, but are not limited thereto. The flavorings may include ingredients capable of providing various flavors or tastes to the user. The vitamin mixtures may be a mixture of at least one of vitamin A, vitamin B, vitamin C, and vitamin E, but are not limited thereto. Also, the aerosol generating material may include an aerosol forming substance, such as glycerin and propylene glycol.

The liquid delivery element may deliver the aerosol generating material of the storage to the heating element. For example, the liquid delivery element may be a wick such as cotton fiber, ceramic fiber, glass fiber, or porous ceramic, but is not limited thereto.

The heating element is an element for heating the aerosol generating material delivered by the liquid delivery element. For example, the heating element may be a metal heating wire, a metal hot plate, a ceramic heater, or the like, but is not limited thereto. In addition, the heating element may include a conductive filament such as nichrome wire and may be located as being wound around the liquid delivery element. The heating element may be heated by a current supply and may transfer heat to the aerosol generating material in contact with the heating element, thereby heating the aerosol generating material. As a result, aerosol may be generated.

For example, the vaporizer 140 may be referred to as a cartomizer or an atomizer, but it is not limited thereto.

When the aerosol generating device 1 according to an embodiment further includes the vaporizer 40, the battery 20 may supply power to heat at least one of the heater assembly 10 or the vaporizer 40, and the controller 30 may control power supplied to at least one of the heater assembly 10 or the vaporizer 40.

When the aerosol generating article 2 is inserted into the aerosol generating device 1 according to an embodiment, the aerosol generating device 1 may operate the heater assembly 10 and/or the vaporizer 40 to generate aerosol from the aerosol generating article 2 and/or the vaporizer 40. The aerosol generated by the heater assembly 10 and/or the vaporizer 40 may pass through the aerosol generating article 2 and may be delivered to the user.

The aerosol generating device body 50 may form an overall appearance of the aerosol generating device 1 according to an embodiment. Elements for operating the aerosol generating device 1 may be located inside the aerosol generating device body 50. For example, the heater assembly 10, the battery 20, the controller 30, and the vaporizer 40 may be located inside the aerosol generating device 1. However, the heater assembly 10, the battery and 20, the controller 30, and the vaporizer 40 are only examples of elements located inside the aerosol generating device 1, and other elements (e.g., a user interface and a sensor) may be further located in addition to the above elements inside the aerosol generating device 1.

An air inlet 50a through which external air is introduced may be formed in the aerosol generating device body 50.

Hereinafter, a heater assembly according to an embodiment will be described in detail with reference to the attached drawings.

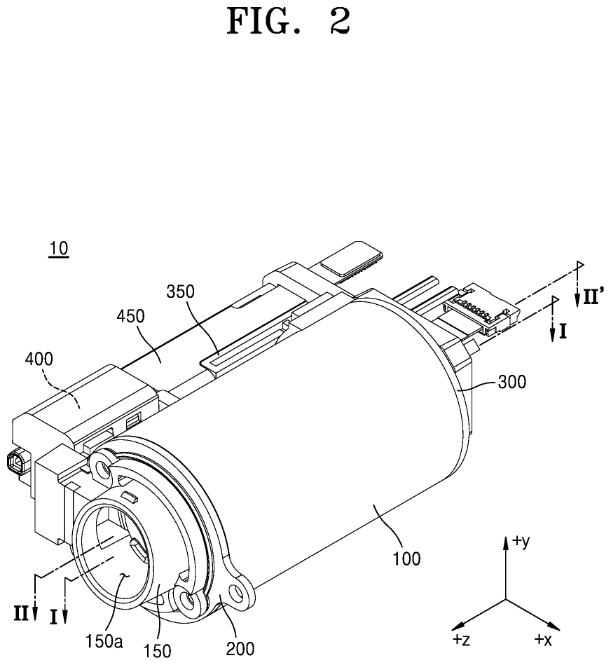

FIG. 2 is a front perspective view illustrating a heater assembly for an aerosol generating device, according to an embodiment.

Referring to FIG. 2, the heater assembly 10 according to an embodiment may include a body 100, a holder 150, a first cover 200, a second cover 300, an air flow passage cover 350, a pressure sensor 400, and a mount member 450.

A receiving space in which the aerosol generating article 2 is accommodated may be formed in an inner space of the body 100. A heater may be located in the receiving space of the body 100 in which the aerosol generating article 2 is accommodated. That is, the inner space of the body 100 may be a space in which the aerosol generating article 2 is accommodated and a magnetic field for heating the aerosol generating article 2 is formed. When the aerosol generating article 2 is accommodated in the receiving space of the body 100, the heater may surround the aerosol generating article 2. The term “heater” used herein may include a coil and a susceptor.

The body 100 may function as a main body of the heater assembly 10 for an aerosol generating device according to an embodiment, and the first cover 200 and the second cover 300 may be coupled to the body 100. The first cover 200 and the second cover 300 may be coupled to the body 100 and supported by the body 100. The body 100 may have a hollow cylindrical shape, but a shape is not limited thereto.

The holder 150 may be located on one side (e.g., +z direction) of the body 100, to support the aerosol generating article 2 accommodated in the receiving space of the body 100. An insertion hole 150a into which the aerosol generating article 2 may be inserted may be formed in the holder 150, and the insertion hole 150a may communicate with the receiving space of the body 100. The aerosol generating article 2 may be accommodated in the receiving space of the body 100 through the insertion hole 150a.

The first cover 200 may be coupled to one side (e.g., +z direction) of the body 100. The first cover 200 may be located between the body 100 and the holder 150 to cover one side of the receiving space of the body 100.

The second cover 300 may be coupled to the other side (e.g., −z direction) of the body 100. The second cover 300 may be coupled to the other side of the body 100 to cover the other side of the receiving space of the body 100.

The air flow passage cover 350 may be located outside (e.g., −x direction) the body 100. An air flow passage may be formed in the air flow passage cover 350, and external air may pass through the air flow passage and move into the heater assembly 10.

The pressure sensor 400 may be located on the air flow passage cover 350 to detect a change in pressure inside the air flow passage. The pressure sensor 400 may be referred to as a puff sensor, and the pressure sensor 400 may detect a user's puff based on various physical changes in the air flow passage or an air flow channel. For example, the pressure sensor 400 may detect the user's puff based on any one of a temperature change, a flow change, a voltage change, and a pressure change.

The mount member 450 may provide a space where a sensor (e.g., the pressure sensor 400) included in the heater assembly 10 is mounted. The mount member 450 may be located on the air flow passage cover 350.

The pressure sensor 400 may be mounted on the mount member 450. In a state where the pressure sensor 400 is mounted on one side of the mount member 450, an element of an aerosol generating device body may be mounted on the other side of the mount member 450 to be electrically connected to the other side of the mount member 450. The element may be at least one of a battery, a controller, and a memory. Information about a change in pressure inside the air flow passage detected by the pressure sensor 400 or information about the user's puff may be transmitted to at least one of the controller or the memory. The mount member 450 may include a metal material, for example, copper (Cu).

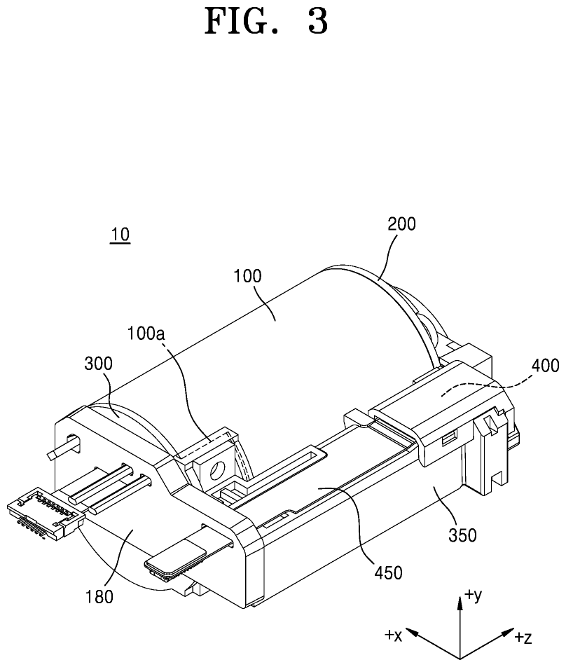

FIG. 3 is a rear perspective view illustrating a heater assembly for an aerosol generating device, according to an embodiment.

Referring to FIG. 3, the heater assembly 10 according to an embodiment may include the body 100, a sealing portion 180, the first cover 200, the second cover 300, the air flow passage cover 350, the pressure sensor 400, and the mount member 450. At least one of elements of the heater assembly 10 may be the same as or similar to at least one of elements of the heater assembly 10 of FIG. 2, and thus, a repeated description will be omitted.

A body groove 100a may be formed in the body 100. At least a part of the second cover 300 may be inserted into the body groove 100a. For example, one side portion (e.g., a portion facing the −x direction) of the second cover 300 may be inserted into the body groove 100a.

The sealing portion 180 may be coupled to the second cover 300 and the air flow passage cover 350. The sealing portion 180 may be located on one side (e.g., −z direction) of the second cover 300 and one side (e.g., −z direction) of the air flow passage cover 350. The sealing portion 180 may seal the one side of the second cover 300 and the one side of the air flow passage cover 350. The sealing portion 180 may include a material such as rubber.

Holes through which one end of the mount member 450, a line for supplying power to a heater, one end of an accommodation detecting unit for detecting insertion of an aerosol generating article, and one end of a temperature detecting unit for detecting a temperature of the heater pass may be formed in the sealing portion 180 and the second cover 300.

Hereinafter, a coupling relationship of the heater assembly 10 according to an embodiment will be described in detail with reference to the attached drawings.

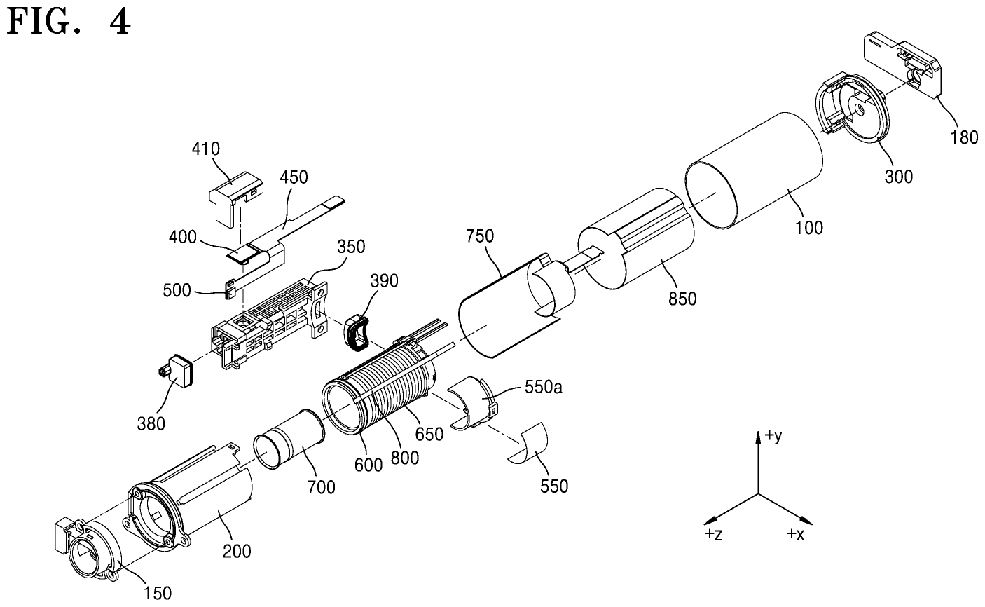

FIG. 4 is an exploded perspective view illustrating the heater assembly for an aerosol generating device according to the embodiment of FIG. 2.

Referring to FIG. 4, the heater assembly 10 according to an embodiment may include the body 100, the holder 150, the sealing portion 180, the first cover 200, the second cover 300, the air flow passage cover 350, the pressure sensor 400, the mount member 450, an article detecting sensor 500, a moisture detecting sensor 550, a support unit 600, a coil 650, a susceptor 700, an accommodation detecting unit 750, a temperature detecting unit 800, and a shielding unit 850.

At least one of elements of the heater assembly 10 according to an embodiment may be the same as or similar to at least one of elements (e.g., the body 100, the holder 150, the first cover 200, and the second cover 300) of the heater assembly 10 for an aerosol generating device of FIGS. 2 and 3, and thus, a repeated description will be omitted.

However, elements of the heater assembly 10 for an aerosol generating device according to an embodiment are not limited thereto, and at least one of the above elements may be omitted or other elements may be added according to an embodiment.

A first air flow cover sealing member 380 and a second air flow cover sealing member 390 may be coupled to the air flow passage cover 350. The first air flow cover sealing member 380 may be located on a portion of the air flow passage cover 350 where air is introduced. The first air flow cover sealing member 380 may prevent introduced air from leaking into a space (e.g., a space inside the aerosol generating device body) other than an air flow passage. The first air flow cover sealing member 380 may be located between the air flow passage cover 350 and an air inlet of the aerosol generating device body.

The second air flow cover sealing member 390 may be located on a portion of the air flow passage cover 350 where air is discharged. The second air flow cover sealing member 390 may prevent air in the air flow passage from leaking into a space other than an inner space of the support unit 600. The second air flow cover sealing member 390 may be located between the second cover 300 and the air flow passage cover 350.

The first air flow cover sealing member 380 and the second air flow cover sealing member 390 may be fitted into the air flow passage cover 350, but a coupling method is not limited thereto. Each of the first air flow cover sealing member 380 and the second air flow cover sealing member 390 may include a rubber material.

The pressure sensor 400 may be located on the air flow passage 350 while being mounted on the mount member 450. The pressure sensor 400 may detect a pressure change in the air flow passage formed inside the air flow passage cover 350 while being located on the air flow passage cover 350.

At least a part of the pressure sensor 400 may be covered by a protective cover 410. The protective cover 410 may be coupled to the air flow passage cover 350 while covering the pressure sensor 400. The protective cover 410 may protect the pressure sensor 400 from a foreign material introduced into the aerosol generating device 1 or external impact applied to the aerosol generating device 1.

The mount member 450 may be located on the air flow passage cover 350. According to an embodiment, the pressure sensor 400 and the article detecting sensor 500 may be mounted together on the mount member 450. That is, the pressure sensor 400 and the article detecting sensor 500 may be electrically connected to an element of the aerosol generating device body through one mount member 450. Accordingly, because the pressure sensor 400 and the article detecting sensor 500 may operate by being electrically connected to the element through one mount member 450, the heater assembly 10 according to an embodiment may implement a compact sensor arrangement (mount) structure.

The article detecting sensor 500 may detect a type of the aerosol generating article accommodated in the receiving space. In an embodiment, the article detecting sensor 500 may detect a type of the aerosol generating article by detecting an identification mark located on an outer surface of the aerosol generating article. The article detecting sensor 500 may detect and recognize the identification mark by detecting a color, a pattern, a shape, etc. of the identification mark.

In an embodiment, the identification mark may be a color, a shape, a barcode, or a quick response (QR) code, and the article detecting sensor 500 may detect the color, the shape, the barcode, or the QR code and may recognize a type of the aerosol generating article.

According to the type of the aerosol generating article detected by the article detecting sensor 500, the controller may heat the aerosol generating article with a preset temperature profile. That is, when information about the type of the aerosol generating article detected by the article detecting sensor 500 is transmitted to the controller or the memory, the memory may retrieve a preset temperature profile according to the input aerosol generating article and the controller may control the coil 650 to heat the aerosol generating article with the retrieved preset temperature profile.

The article detecting sensor 500 may include a color sensor, an optical sensor, a near field communication (NFC) reader, or a radio-frequency identification (RFID) reader according to the pf the identification mark. However, the article detecting sensor 500 is not limited as long as it may recognize the identification mark.

In an embodiment, the article detecting sensor 500 may include a color sensor. The color sensor may include a red green blue (RGB) sensor or an XYZ optical sensor for measuring, determining, or distinguishing a color of an identification mark. The RGB sensor may include light sources of three colors, and may detect color information by reflecting light on an object. The XYZ optical sensor may include an optical-digital converter, and may detect xy chromaticity coordinates according to a Commission Internationale de l'Eclairage (CIE) 1931 color space. Also, the color sensor may include a filter for blocking infrared rays in a visible light region for more accurate color measurement.

In an embodiment, the article detecting sensor 500 may include an infrared sensor, an ultrasonic sensor, a hardness measurement sensor (push-pull gauge), a capacitance sensor, and a resistance measurement sensor.

The article detecting sensor 500 may be located on the air flow passage cover 350 at a position spaced apart from the pressure sensor 400. That is, the article detecting sensor 500 may be mounted on the mount member 450, at a position different from that of the pressure sensor 400.

The article detecting sensor 500 may be located on the air flow passage cover 350 while being mounted on the mount member 450 to face the receiving space in which the aerosol generating article is accommodated. Accordingly, the heater assembly 10 according to an embodiment may have an arrangement structure in which the article detecting sensor 500 may easily detect the identification mark of the aerosol generating article.

The moisture detecting sensor 550 may be located on the support unit 600 inside the body 100 to detect moisture in the aerosol generating article accommodated in the receiving space. When the susceptor 700 heats the aerosol generating article due to a magnetic field generated by the coil 650, aerosol may be generated. The generated aerosol may include some moisture, and the moisture may wet or be attached to the aerosol generating article. In an embodiment, the moisture detecting sensor 550 may detect the amount of moisture wetting or attached to the aerosol generating article and may transmit information about the amount to the controller or the memory. When the moisture detecting sensor 550 detects that the amount of moisture wetting or attached to the aerosol generating article is equal to or greater than a preset amount, the controller may generate a signal for replacing the aerosol generating article or a signal indicating that a usage cycle has expired.

In an embodiment, the moisture detecting sensor 550 may detect a change in electromagnetic characteristics caused by an object (the aerosol generating article) adjacent to the heater assembly 10. For example, the moisture detecting sensor 550 may be a capacitance sensor or a magnetic proximity sensor, but a type of the moisture detecting sensor 550 is not limited thereto.

At least a part of the moisture detecting sensor 550 may include a curved surface to correspond to an outer shape of the aerosol generating article. Accordingly, regardless of a receiving direction of the aerosol generating article accommodated in the receiving space, a distance between the moisture detecting sensor 550 and the aerosol generating article is substantially constant along a circumferential direction of the moisture detecting sensor 550. Accordingly, the moisture detecting sensor 550 may accurately detect the amount of moisture in the aerosol generating article regardless of the receiving direction of the aerosol generating article.

The moisture detecting sensor 550 may be located on the support unit 600 through a sensor bracket 550a. That is, the moisture detecting sensor 550 may be coupled to the sensor bracket 550a and may be located on the support unit 600. At least a part of the sensor bracket 550a may include a curved surface to correspond to an outer shape of the support unit 600. The moisture detecting sensor 550 may be attached to the sensor bracket 550a through a tape, but a coupling method between the moisture detecting sensor 550 and the sensor bracket 550a is not limited thereto.

The support unit 600 may be located inside the body 100 to support the coil 650. When the aerosol generating article is accommodated in the receiving space of the body 100, the support unit 600 may surround the aerosol generating article. The support unit 600 may be referred to as a bobbin and may have a hollow cylindrical shape, but a shape is not limited thereto as long as the support unit 600 may support the coil 650.

The coil 650 may be located inside the body 100 to cause the susceptor 700 located in the receiving space to generate heat. When the aerosol generating article is accommodated in the receiving space of the body 100, the coil 650 may surround the aerosol generating article.

The coil 650 may apply an alternating magnetic field to the susceptor. When power is supplied from the battery to the coil, a magnetic field may be formed inside the coil. When alternating current is applied to the coil, a direction of the magnetic field formed inside the coil may be continuously changed. When the susceptor is located inside the coil and is exposed to an alternating magnetic field whose direction is periodically changed, the susceptor may generate heat and the aerosol generating article accommodated in the receiving space of the body 100 may be heated by the susceptor. Accordingly, aerosol may be generated.

The coil 650 may extend in a longitudinal direction (e.g., z-axis direction) of the aerosol generating device 1. For example, the coil 650 may extend to a length corresponding to a length of the support unit 600, or may extend to a length shorter than the length of the support unit 600.

The coil 650 may be located at a position suitable to apply an alternating magnetic field to the susceptor 700. For example, the coil 650 may be located on the support unit 600 to be located at a position corresponding to the susceptor 700. The efficiency with which an alternating magnetic field of the coil 650 is applied to the susceptor 700 may be improved due to the size and arrangement of the coil 650.

When an amplitude or a frequency of an alternating magnetic field formed by the coil 650 is changed, a degree to which the susceptor 700 heats the aerosol generating article may also be changed. Because an amplitude or a frequency of a magnetic field by the coil 650 may be changed by power applied to the coil 650, the aerosol generating device 1 may control heating of the aerosol generating article by adjusting power applied to the coil 650. For example, the aerosol generating device 1 may control an amplitude and a frequency of alternating current applied to the coil 650.

In an example, the coil 650 may be implemented as a solenoid. The coil 650 may be a solenoid wound along a direction (e.g., the z-axis direction) in which the support unit 600 extends, and the susceptor 700 and the aerosol generating article may be located in an inner space of the solenoid. A material of a wire constituting the solenoid may be copper (Cu). However, the disclosure is not limited thereto, and an alloy including any one or at least one of silver (Ag), gold (Au), aluminum (Al), tungsten (W), zinc (Zn), and nickel (Ni) may be a material of the wire constituting the solenoid.

The susceptor 700 may be located inside the body 100 and surround the aerosol generating article accommodated in the receiving space. In an embodiment, the receiving space may be defined as an inner space of the susceptor 700. The susceptor 700 may heat the aerosol generating article when a magnetic field is applied by the coil 650 to generate heat. The susceptor 700 may include a stainless steel (SUS) material, but a material is not limited thereto.

The accommodation detecting unit 750 may be located inside the body 100 and may detect whether the aerosol generating article is accommodated in the receiving space. Information detected by the accommodation detecting unit 750 may be transmitted to the controller or the memory of the aerosol generating device. When the accommodation detecting unit 750 detects that the aerosol generating article is accommodated, the controller may generate a signal for operating an element (e.g., the coil 650) of the aerosol generating device.

In an example, the aerosol generating article may include a metal material such as aluminum, and the accommodation detecting unit 750 may include an inductance sensor for detecting a change in inductance occurring when the aerosol generating article is accommodated in the receiving space.

In another example, the accommodation detecting unit 750 may include a capacitance sensor or a magnetic proximity sensor for detecting a change in electromagnetic characteristics due to the aerosol generating article adjacent to the receiving space. However, the disclosure is not limited thereto, and the accommodation detecting unit 750 may include another type of sensor such as an optical sensor, a temperature sensor, or a resistance sensor.

The accommodation detecting unit 750 may surround the support unit 600 and the coil 650 and surround the receiving space of the body 100. Accordingly, when the aerosol generating article is accommodated in the receiving space of the body 100, the accommodation detecting unit 750 may surround the aerosol generating article.

The temperature detecting unit 800 may be located inside the body 100 to detect a temperature inside the receiving space of the body 100. In an embodiment, the temperature detecting unit 800 may detect a temperature of at least one of the coil 650 or the susceptor 700. Information detected by the temperature detecting unit 800 may be transmitted to the controller or the memory of the aerosol generating device 1.

The temperature detecting unit 800 may extend in one direction (e.g., the z-axis direction) while being located on one side of the coil 650. The temperature detecting unit 800 may be a thermocouple wire, but may not be limited as long as it may detect a temperature inside the receiving space.

The shielding unit 850 may be located inside the body 100 and may surround the support unit 600 and the coil 650. The shielding unit 850 may prevent a magnetic field generated inside the body 100 from propagating to the outside. The shielding unit 850 may include a material such as aluminum (Al) or silver (Ag) and may have a hollow cylindrical shape, but a material and a shape are not limited thereto.

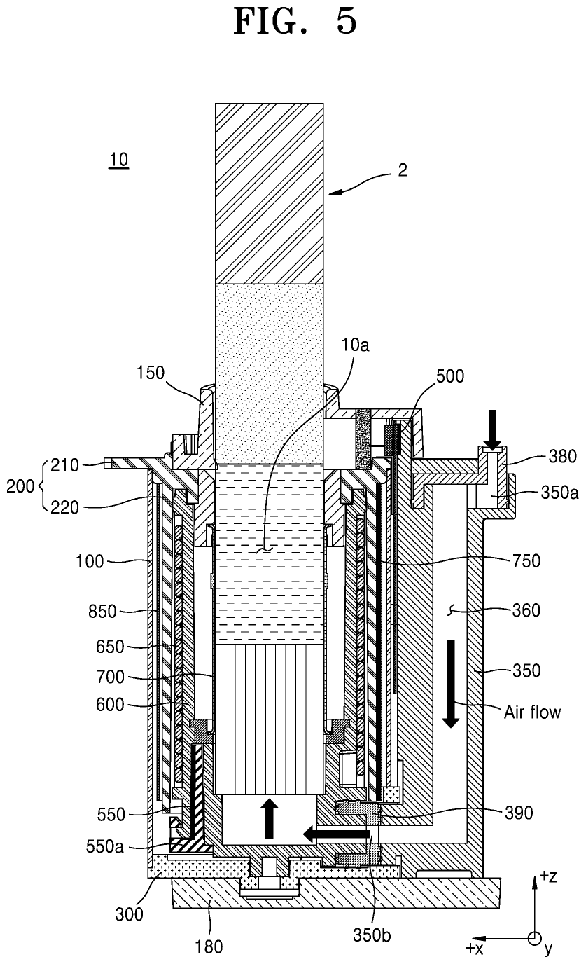

FIG. 5 is a cross-sectional view illustrating the heater assembly for an aerosol generating device according to an embodiment taken along line I-I′ of FIG. 2, showing a state where an aerosol generating article is inserted into the heater assembly. FIG. 5 illustrates a state where an aerosol generating article is inserted into the heater assembly of FIG. 2.

Referring to FIG. 5, the heater assembly 10 according to an embodiment may include the body 100, the holder 150, the sealing portion 180, the first cover 200, the second cover 300, the air flow passage cover 350, the article detecting sensor 500, the moisture detecting sensor 550, the support unit 600, the coil 650, the susceptor 700, the accommodation detecting unit 750, and the shielding unit 850.

At least one of elements of the heater assembly 10 according to an embodiment may be the same as or similar to at least one of elements of the heater assembly 10 for an aerosol generating device of FIG. 4, and thus, a repeated description will be omitted.

The body 100 may be an outermost element from among elements of the heater assembly 10 (e.g., the moisture detecting sensor 550, the support unit 600, the coil 650, the susceptor 700, the accommodation detecting unit 750, the temperature detecting unit 800, and the shielding unit 850). That is, the moisture detecting sensor 550, the support unit 600, the coil 650, the susceptor 700, the accommodation detecting unit 750, the temperature detecting unit 800, and the shielding unit 850 may be located inside the body 100. The body 100 may include a material such as steel use stainless (SUS) or aluminum.

As the first cover 200 is coupled to an upper portion (a portion facing the +z direction) of the body 100 and the second cover 300 is coupled to a lower portion (a portion facing the −z direction) of the body 100, a receiving space 10a for accommodating the aerosol generating article 2 may be formed inside the body 100.

The aerosol generating article 2 and the susceptor 700 may be located in the receiving space 10a. In an embodiment, when the heater assembly 10 includes the susceptor 700 as shown in FIG. 5, the aerosol generating article 2 may be accommodated inside the susceptor 700 and may be heated by the susceptor 700. In another embodiment, when the susceptor is located as pieces, flakes, or strips inside the aerosol generating article 2, the coil 650 may be located at a position corresponding to the susceptor and may cause the susceptor to generate heat by applying a magnetic field to the susceptor.

When the susceptor is located inside the aerosol generating article 2, because the heater assembly 10 for an aerosol generating device according to an embodiment does not include the susceptor 700 surrounding the aerosol generating article 2, in a space where the susceptor 700 is not located, other elements may be located instead. Accordingly, space utilization of the heater assembly 10 for an aerosol generating device according to an embodiment may be improved.

Although not shown, a material for reflecting heat generated by the coil 650 and/or the susceptor 700 to the receiving space 10a may be deposited on at least a part of an inner surface of at least one of the body 100, the first cover 200, and the second cover 300. Accordingly, because the probability that heat generated by the coil 650 and/or the susceptor 700 is directly released to the outside of the heater assembly 10 decreases, insulation performance of the heater assembly 10 may be improved. For example, the material deposited on the inner surface of at least one of the body 100, the first cover 200, and the second cover 300 may include a metal material such as silver (Ag).

The first cover 200 may include a cover body 210 and a cover insulation member 220.

The cover body 210 may function as a main body of the first cover 200. The holder 150 may be located on one side (e.g., the +z direction) of the cover body 210, and the body 100 may be located on the other side (e.g., the −z direction) of the cover body 210.

The cover insulation member 220 may extend in one direction (e.g., the −z direction) from the cover body 210 and may be located outside the coil 650. Accordingly, the cover insulation member 220 may function as a physical barrier for preventing heat generated in the receiving space 10a from being released to the outside of the heater assembly 10. Accordingly, because the heater assembly 10 for an aerosol generating device according to an embodiment uses a double physical barrier through the cover insulation member 220 in addition to the body 100, insulation performance may be improved.

The cover insulation member 220 may be located between the body 100 and the coil 650. In detail, the cover insulation member 220 may be located between the accommodation detecting unit 750 and the coil 650, inside the shielding unit 850. In an embodiment, the cover insulation member 220 may be integrally formed with the cover body 210.

The air flow passage cover 350 may be located on one side (e.g., the −x direction) of the body 100. An air flow passage 360 may be formed in the air flow passage cover 350. Air may be introduced into the heater assembly 10 through the air flow passage 360 and may move to the receiving space 10a in which the aerosol generating article 2 is accommodated. That is, the air flow passage 360 may communicate with the receiving space 10a, and at least part of the air moving through the air flow passage 360 may pass through the aerosol generating article 2 accommodated in the receiving space 10a and may be discharged to the outside.

An air inlet 350a may be formed in the air flow passage cover 350. Air may be introduced into the air flow passage 360 in the air flow passage cover 350 through the air inlet 350a. The air inlet 350a may be formed at one end of the air flow passage cover 350 and a first air flow passage cover sealing member 380. The air inlet 350a may communicate with the air inlet of the aerosol generating device body.

In an embodiment, the heater assembly 10 according to an embodiment has a structure in which air is introduced only through the air flow passage 360 formed in the air flow passage cover 350 and moves to the receiving space 10a. Accordingly, because only one flow of air introduced from the outside may be generated by the air flow passage 360 formed in the air flow passage cover 350, the pressure sensor 400 may measure pressure of the air flow passage 360 more precisely and accurately.

In an embodiment, the air inlet 350a may be spaced apart from the holder 150 through which the aerosol generating article 2 is inserted. Accordingly, because the air inlet 350a may be spaced apart by a certain distance from the aerosol generating article 2 which the user touches and inhales with his/her mouth, a pressure change value (Δ value) inside the aerosol generating device may increase during inhalation.

The pressure change value (Δ value) is a measure of fluidity of air/air flow in the aerosol generating device, and as the pressure change value (Δ value) increases, fluidity of air may increase. This is because as a difference between pressure inside the aerosol generating device and external pressure (atmospheric pressure that is almost constant) increases, air may be easily introduced into the aerosol generating device. When the pressure change value (Δ value) is large, it may mean that pressure is significantly lower than initial pressure inside the aerosol generating device.

A comparative example where the air inlet 350a is located in the holder 150 has a structure in which a portion where the user inhales air and a portion where air is introduced are close to each other. Accordingly, in the comparative example, because air is introduced through the portion where the user inhales, the pressure change value (Δ value) is easily affected by the user's inhalation. For example, when the pressure change value (Δ value) inside the aerosol generating device does not increase according to the user's usage characteristics (e.g., when the inhalation is weak), it may be difficult for external air to be introduced into the aerosol generating device. Accordingly, the comparative example has a problem in that mobility of air in the aerosol generating device is deteriorated.

According to the heater assembly 10 according to an embodiment, the air flow passage 360 is not formed in the holder 150 or the body 100, but is formed in the separate air flow passage cover 350 located on one side surface of the body 100. That is, the air inlet 350 that is a portion of the air flow passage 360 may be spaced apart by a certain distance from the aerosol generating article 2 which the user touches and inhales. Accordingly, because the heater assembly 10 according to an embodiment has a structure in which the pressure change value (Δ value) is less affected by the user's inhalation, the pressure change value (Δ value) may increase regardless of inhalation characteristics. Accordingly, mobility of air in the aerosol generating device may be increased.

An air outlet 350b may be formed in the airflow passage cover 350. The air outlet 350b may be formed in the air flow passage cover 350 at a position spaced apart from the air inlet 350a. Air may move from the air flow passage cover 350 to the receiving space 10a inside the heater assembly 10 through the air outlet 350b. This is because a hole communicating with the air outlet 350b is formed in the support unit 600. The air outlet 350b may be formed at the other end of the air flow passage cover 350 communicating with the hole of the support unit 600 and a second air flow cover sealing member 390.

Air introduced into the air inlet of the aerosol generating device body may pass through the air inlet 350a formed in the air flow passage cover 350, the air flow passage 360, the air outlet 350b, and the inner space of the support unit 600 and may move to the receiving space 10a.

The article detecting sensor 500 may be located on the air flow passage cover 350 to be located on one side (e.g., the −x direction) of the aerosol generating article. The article detecting sensor 500 may be disposed on the air flow passage cover 350 to be located at a position corresponding to an identification mark in order to detect the identification mark (not shown) located on an outer surface of the aerosol generating article 2.

The moisture detecting sensor 550 may be located on one side (e.g., a +x direction) of the aerosol generating article 2. The moisture detecting sensor 550 may be located to correspond to one segment of the aerosol generating article 2 including an aerosol generating material. To this end, a sensor bracket 550a may be coupled to the support unit 600 to be located at a position corresponding to the one segment of the aerosol generating article 2. Moisture generated as aerosol is generated from the aerosol generating material included in the aerosol generating article 2 may intensively wet or be attached to the one segment. Because the moisture detecting sensor 550 is located to correspond to the one segment, the moisture detecting sensor 550 may accurately and precisely measure moisture in the aerosol generating article 2. For example, the moisture detecting sensor 550 may be spaced downward (e.g., the −z direction) from a middle portion of the support unit 600.

The support unit 600 may surround the receiving space 10a, and may support the coil 650 that causes the susceptor 700 to generate heat. The support unit 600 may be located inside the cover insulation member 220 and may be supported by the first cover 200.

The coil 650 may be located on the support unit 600 and may cause the susceptor located in the receiving space 10a to generate heat. The coil 650 may be wound around an outer surface of the support unit 600. The coil 650 may have a circular cross-sectional shape when being cut based on a plane (xz plane) passing through a first direction (e.g., the z-axis direction) in which the support unit 600 extends and a second direction (e.g., an x-axis direction) intersecting the direction in which the support unit 600 extends. That is, when the coil 650 is viewed in a y-axis direction, the coil 650 may have a circular cross-sectional shape.

The susceptor 700 may surround the receiving space 10a, and may heat the aerosol generating article 2 located in the receiving space 10a. The susceptor 700 may be located inside the support unit 600 and may be supported by the support unit 600. The susceptor 700 may have a hollow cylindrical shape, but a shape is not limited thereto.

The accommodation detecting unit 750 may surround the receiving space 10a. The accommodation detecting unit 750 may be located between the cover insulation member 220 and the shielding unit 850, outside the coil 650.

The shielding unit 850 may surround the receiving space 10a in an inner space of the body 100 and may be located between the body 100 and the accommodation detecting unit 750. That is, because the shielding unit 850 is located outside the coil 650, the shielding unit 850 may shield a magnetic field generated by the coil 650.

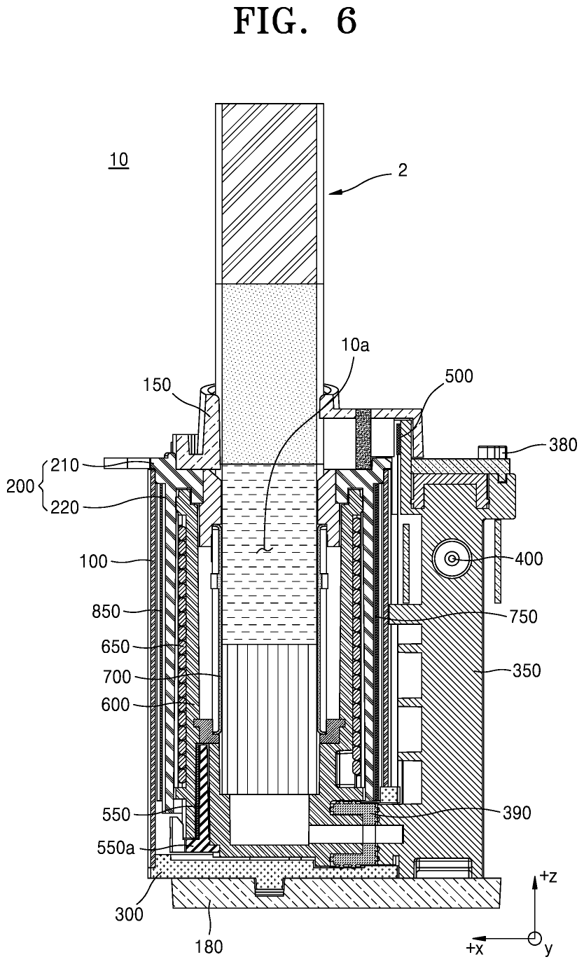

FIG. 6 is a cross-sectional view illustrating the heater assembly for an aerosol generating device according to an embodiment taken along line II-II′ of FIG. 2, showing a state where an aerosol generating article is inserted into the heater assembly.

Referring to FIG. 6, the heater assembly 10 according to an embodiment may include the body 100, the holder 150, the sealing portion 180, the first cover 200, the second cover 300, the air flow passage cover 350, the pressure sensor 400, the article detecting sensor 500, the moisture detecting sensor 550, the support unit 600, the coil 650, the susceptor 700, the accommodation detecting unit 750, and the shielding unit 850.

At least one of elements of the heater assembly 10 according to an embodiment may be the same as or similar to at least one of elements of the heater assembly 10 for an aerosol generating device of FIG. 5, and thus, a repeated description will be omitted.

The pressure sensor 400 may be located on the air flow passage cover 350 and may detect a change in pressure of the air flow passage. Although the pressure sensor 400 is spaced upward (+z direction) from a middle portion of the air flow passage cover 350 in FIG. 6, this is an example and a position may be set in various ways as long as a pressure change inside the air flow passage may be detected.

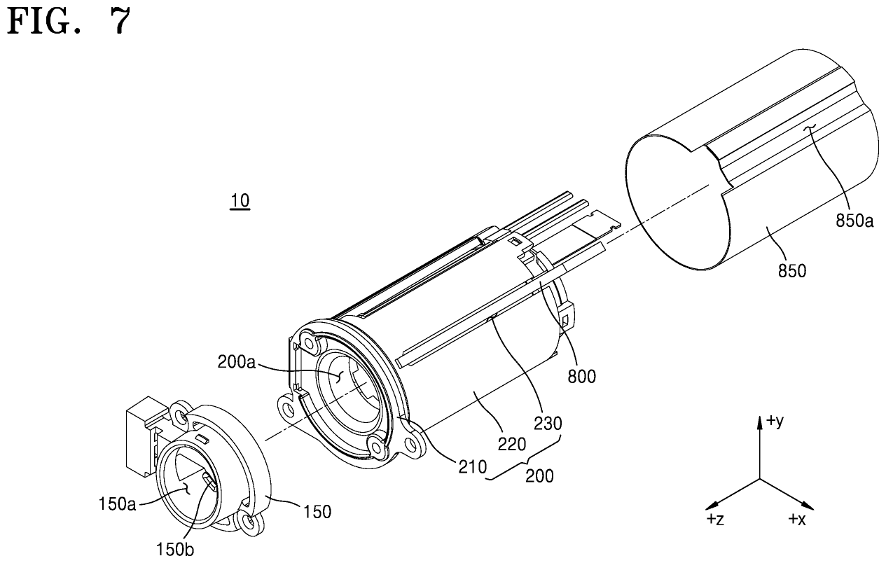

FIG. 7 is an exploded perspective view illustrating a holder, a first cover, a temperature detecting unit, and a shielding unit included in a heater assembly for an aerosol generating device, according to an embodiment. A coupling relationship between the holder, the first cover, the temperature detecting unit, and the shielding unit will be described with reference to the attached drawings.

Referring to FIG. 7, the heater assembly 10 according to an embodiment may include the holder 150, the first cover 200, the temperature detecting unit 800, and the shielding unit 850.

At least one of elements of the heater assembly 10 according to an embodiment may be the same as or similar to at least one of elements of the heater assembly 10 for an aerosol generating device of FIGS. 4 and 5, and thus, a repeated description will be omitted.

The holder 150 may be located on one side (e.g., the +z direction) of the first cover 200 and may be coupled to the first cover 200. The holder 150 may be coupled to the first cover 200 by using a coupling member such as a screw, but a coupling method is not limited thereto.

The holder 150 may include a ridge 150b supporting the aerosol generating article 2 inserted into the insertion hole 150a. The ridge 150b may protrude toward the insertion hole 150a and may contact the aerosol generating article 2 inserted into the insertion hole 150a. In an embodiment, a plurality of ridges 150b may be arranged along a circumferential direction of the insertion hole 150a.

The first cover 200 may include the cover body 210, the cover insulation member 220, and an avoidance groove 230.

Because an article insertion portion 200a is formed in the cover body 210, the aerosol generating article inserted through the insertion hole 150a may pass through the cover body 210 and may be accommodated in the receiving space 10a. Although not shown, a hole into which a coupling member such as a screw may be inserted may be formed in the cover body 210, and as the screw is coupled through the hole, the cover body 210 may be fixedly coupled to the aerosol generating device body.

The cover insulation member 220 may extend in one direction (e.g., the −z direction) from the cover body 210 and may surround the coil 650 and the susceptor 700.

The avoidance groove 230 may be formed in the cover insulation member 220. The avoidance groove 230 may extend together along a direction (e.g., the z-axis direction) in which the cover insulation member 220 extends. A plurality of avoidance grooves 230 may be formed in the cover insulation member 220 to be spaced apart from each other.

At least a part of the temperature detecting unit 800 may be inserted into the avoidance groove 230. Accordingly, when assembly of the heater assembly 10 according to an embodiment is completed, the cover insulation member 220 and the temperature detecting unit 800 may be located inside the body without interfering with each other. Accordingly, because it is not necessary to secure a separate space for placing the temperature detecting unit 800 apart from the cover insulation member 220 inside the heater assembly 10, the heater assembly 10 may be miniaturized.

When the cover insulation member 220 includes a plurality of avoidance grooves 230, the temperature detecting unit 800 may be inserted into one avoidance groove 230 and a line of the coil 650 may be inserted into another avoidance groove 230. Accordingly, the heater assembly 10 may be further miniaturized.

The shielding unit 850 may surround the cover insulation member 220 and may be located inside the temperature detecting unit 800. In this case, a temperature detecting unit insertion groove 850a into which at least a part of the temperature detecting unit 800 is inserted may be formed in the shielding unit 850. Accordingly, when assembly of the heater assembly 10 according to an embodiment is completed, the temperature detecting unit 800 and the shielding unit 850 may be located inside the body without interfering with each other.

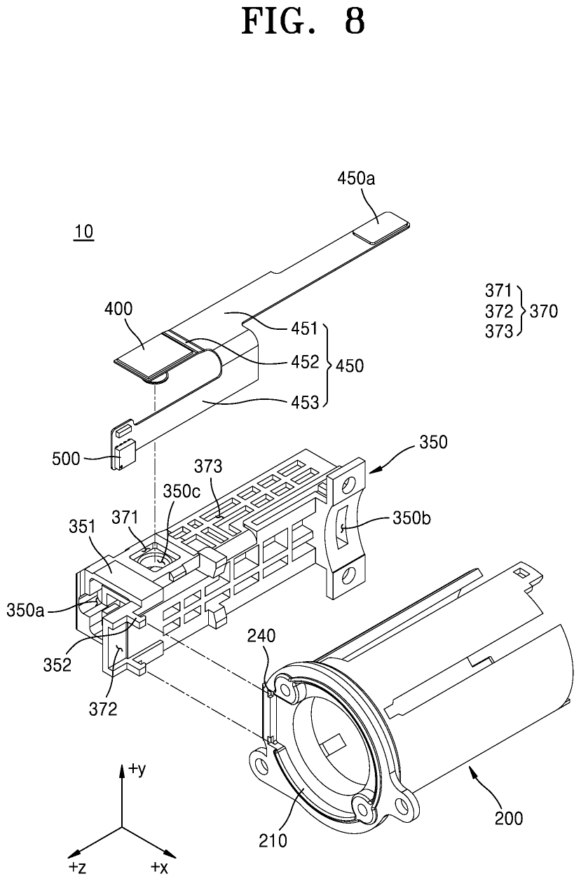

FIG. 8 is an exploded perspective view illustrating a first cover, an air flow passage cover, and a mount member included in a heater assembly for an aerosol generating device, according to an embodiment. Hereinafter, a coupling relationship between the first cover, the air flow passage cover, and the mount member will be described with reference to the attached drawings.

Referring to FIG. 8, the heater assembly 10 according to an embodiment may include the first cover 200, the air flow passage cover 350, the pressure sensor 400, the mount member 450, and the article detecting sensor 500.

At least one of elements of the heater assembly 10 according to an embodiment may be the same as or similar to at least one of elements of the heater assembly 10 for an aerosol generating device of FIGS. 4 to 7, and thus, a repeated description will be omitted.

The air flow passage 350 may include an air flow passage cover body 351 and a cover locking member 352.

The air flow passage cover body 351 may function as a main body of the air flow passage cover 350. An air flow passage may be formed inside the air flow passage cover body 351, and the air inlet 350a and the air outlet 350b may be formed at positions spaced apart from each other. The air flow passage, the air inlet 350a, and the air outlet 350b may communicate with each other.

The cover locking member 352 may be formed on the air flow passage cover body 351. The cover locking member 352 may protrude from the air flow passage cover body 351 toward the first cover 200. The cover locking member 352 may be inserted into an air flow passage cover coupling groove 240 formed in the cover body 210, and when the cover locking member 352 is inserted into the air flow passage cover coupling groove 240, the air flow passage cover 350 may be fixedly coupled to the first cover 200. Accordingly, according to the heater assembly 10 according to an embodiment, the first cover 200 and the air flow passage cover 350 may be coupled to each other by using a simple hook coupling structure. The air flow passage cover coupling groove 240 may be formed in a top surface (surface facing the +z direction) of the cover body 210.

The air flow passage cover 350 may further include a receiver 370.

The receiver 37 may be formed in the air flow passage cover body 351 so that the mount member 450 and the sensors (e.g., 400 and 500) are located on the air flow passage cover 350.

The receiver 370 may include a pressure sensor receiver 371, an article detecting sensor receiver 372, and a mount member receiver 373. The receivers (i.e., 371, 372, and 373) may communicate with each other, and may be located at different portions of the air flow passage cover 350.

In an embodiment, the pressure sensor receiver 371 may be located on a first side surface (portion facing a +y direction) of the air flow passage cover 350, the article detecting sensor receiver 372 may be located on a second side surface (e.g., portion facing the +x direction) of the air flow passage cover 350, and the mount member receiver 373 may be located on the first side surface (portion facing the +y direction) and the second side surface (portion facing the +x direction) of the air flow passage cover 350.

The pressure sensor 400 may be accommodated in the pressure sensor receiver 371. The pressure sensor 400 may detect an internal pressure of the air flow passage while being accommodated in the pressure sensor receiver 371. A through-hole 350c communicating with the pressure sensor receiver 371 may be formed in the air flow passage cover body 351, and the pressure sensor 400 may be inserted into the through-hole 350c and may easily detect a pressure change inside the air flow passage. This is because the through-hole 350c communicates with the air flow passage.

The article detecting sensor 500 may be accommodated in the article detecting sensor receiver 372. The article detecting sensor 500 may detect an identification mark of the aerosol generating article while being accommodated in the article detecting sensor receiver 382.

As the mount member 450 is be accommodated in the receiver 370, the mount member 450 may be coupled to the air flow passage cover 350. The pressure sensor 400 and the article detecting sensor 500 may be mounted together through one mount member 450. Accordingly, the present sensor 400 and the article detecting sensor 500 may be simultaneously located on the air flow passage cover 350 through a compact mounting structure.

The mount member 450 may include a first mount member 451, a second mount member 452, and a third mount member 453.

The first mount member 451 may function as a main body of the mount member 450, and may be connected to the second mount member 452, the third mount member 453, and a connector 450a. The first mount member 450 may extend together along a direction (e.g., the x z-axis direction) in which the air flow passage cover 350 extends and may be accommodated in the mount member receiver 373.

The second mount member 452 may extend in one direction (e.g., the +z direction) from the first mount member 451. The pressure sensor 400 may be located on the second mount member 452. The pressure sensor 400 may be accommodated in the pressure sensor receiver 371 while being mounted on the second mount member 452. The second mount member 452 may be accommodated in the mount member receiver 373 and the pressure sensor receiver 371.

The third mount member 453 may include a first portion extending in one direction (e.g., the +x direction) from the first mount member 451, a second portion extending in one direction (e.g., a −y direction) from the first portion, and a third portion extending in one direction (e.g., the +z direction) from the second portion. The article detecting sensor 500 may be located on the third mount member 453. In detail, the article detecting sensor 500 may be located on the third portion of the third mount member 453. The article detecting sensor 500 may be accommodated in the pressure sensor receiver 371 while being mounted on the third mount member 453. The third mount member 453 may be accommodated together in the mount member receiver 373 and the pressure sensor receiver 371.

The mount member 450 may include the connector 450a. The connector 450a may be connected to an end of the first mount member 451, and may pass through the sealing portion and may be connected to the memory or the controller of the aerosol generating device body. Information detected by the pressure sensor 400 and the article detecting sensor 500 may be transmitted to the memory or the controller through the connector 450a of the mount member 450. The connector 450a, the third mount member 453, the second mount member 452, and the first mount member 451 may be integrally formed with each other.

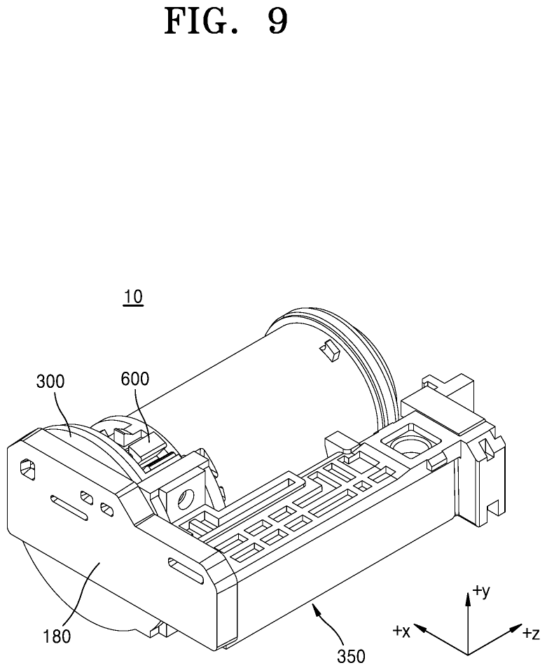

FIG. 9 is a rear perspective view illustrating a heater assembly for an aerosol generating device, according to an embedment, showing a coupling relationship between a sealing portion, a second cover, an air flow passage cover, and a support unit. Hereinafter, a coupling relationship between the sealing portion 180, the second cover 300, the air flow passage cover 350, and the support unit 600 will be described.

The heater assembly 10 according to an embodiment may include the sealing portion 180, the second cover 300, the air flow passage cover 350, and the support unit 600. At least one of elements of the heater assembly 10 may be the same as or similar to at least one of elements of the heater assembly 10 for an aerosol generating device of FIGS. 4 to 8, and thus, a repeated description will be omitted.

An air flow passage inside the air flow passage cover 350 may communicate with the inside of the support unit 600, and the air flow passage cover 350 may be coupled to the support unit 600 through the second cover 300 without being directly connected to the support unit 600.

In an embodiment, the air flow passage cover 350 may be coupled to the second cover 300 through a coupling member such as a screw, but a coupling method is not limited thereto. Also, the sealing portion 180 may be coupled to the second cover 300 and the air flow passage cover 350 on lower sides (e.g., the −z direction) of the second cover 300 and the air flow passage cover 350.

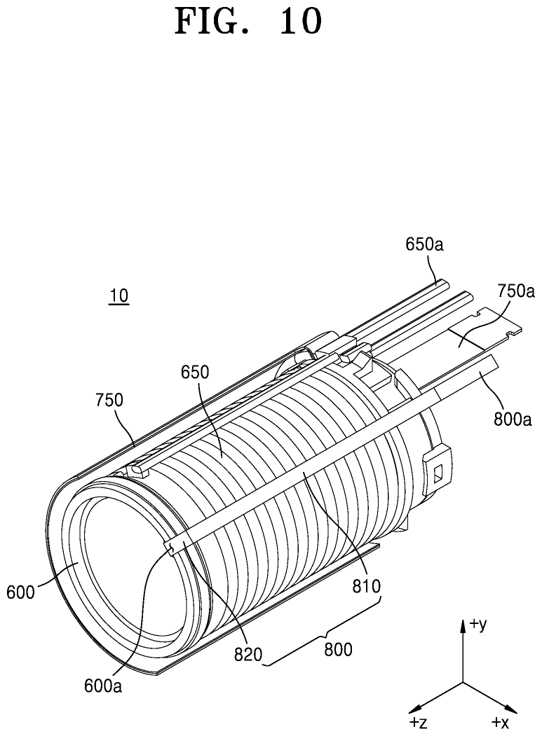

FIG. 10 is a combined perspective view illustrating a support unit, a heater, an accommodation detecting unit, and a temperature detecting unit included in a heater assembly for an aerosol generating device, according to an embodiment. Hereinafter, a coupling relationship between the support unit 600, the coil 650, the accommodation detecting unit 750, and the temperature detecting unit 800 will be described with reference to the attached drawings.

Referring to FIG. 10, the heater assembly 10 according to an embodiment may include the support unit 600, the coil 650, the accommodation detecting unit 750, and the temperature detecting unit 800. At least one of elements of the heater assembly 10 may be the same as or similar to at least one of elements of the heater assembly 10 for an aerosol generating device of FIGS. 4 to 9, and thus, a repeated description will be omitted.

The coil 650 may be located outside the support unit 600, and may be electrically connected to at least one of the battery, the memory, or the controller of the aerosol generating device body through a connector 650a.

The accommodation detecting unit 750 may surround the outside of the support unit 600 and the coil 650, and may extend along a direction (e.g., the z-axis direction) in which the support unit 600 and the coil 650 extend. The accommodation detecting unit 750 may be electrically connected to at least one of the battery, the memory, or the controller of the aerosol generating device body through a connector 750a.

The accommodation detecting unit 750 may surround a part of the outside of the support unit 600 and the coil 650, inside the body. Accordingly, according to the heater assembly 10 according to an embodiment, the accommodation detecting unit 750 may be easily inserted into the body compared to a comparative example in which the accommodation detecting unit 750 surrounds the entire outside of the support unit 600 and the coil 650. Accordingly, the ease of assembly of the heater assembly 10 may be improved.

The temperature detecting unit 800 may be located on one side surface (e.g., the +x direction) of the support unit 600 inside the body to detect a temperature of at least one of the coil 650 or the susceptor. In an embodiment, the temperature detecting unit 800 may contact the support unit 600 or the susceptor to detect a temperature of the coil 650 or the susceptor.

The temperature detecting unit 800 may include a detection body 810 and a detection connector 820.

The detection body 810 may function as a main body of the temperature detecting unit 800, and may extend along a direction (e.g., the z-axis direction) in which the heater assembly 10 extends. The detection body 810 may be located between the body and the shielding unit. The detection body 810 may be integrally formed with the detection connector 820.

The detection connector 820 may be connected to the support unit 600 or the susceptor. The detection connector 820 may have a bent “┐” shape. The detection connector 820 may include a first portion extending in a direction (e.g., the −x direction) intersecting a direction in which the detection body 810 extends and a second portion extending in a direction (e.g., the −z direction) intersecting the direction which the first portion extends. At least a part of the first portion may be supported on the support unit 600, and at least a part of the second portion may be connected to the support unit 600 or the susceptor. In this case, a groove 600a into which the first portion of the detection connector 820 is inserted may be formed in the support unit 600.

The temperature detecting unit 800 may be electrically connected to at least one of the battery, the memory, or the controller of the aerosol generating device body through the connector 800a. The connector 800a may extend along one direction (e.g., the −z direction) from the detection body 810.

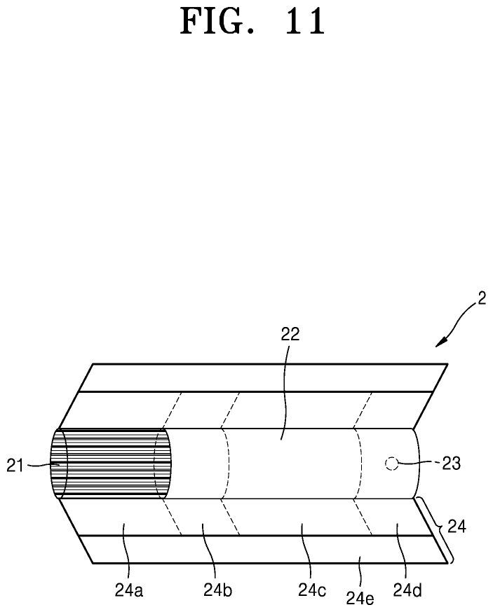

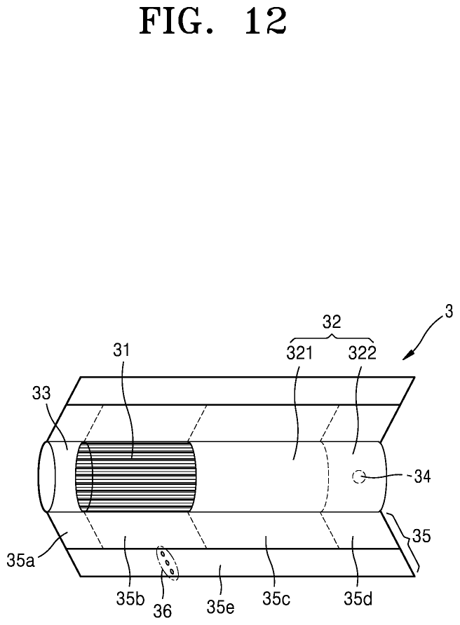

Hereinafter, the examples of the aerosol generating article 2 will be described with reference to FIGS. 11 and 12.

FIGS. 11 and 12 illustrate examples of the aerosol generating article.

Referring to FIG. 11, the aerosol generating article 2 includes a tobacco rod 21 and a filter rod 22.

FIG. 11 illustrates that the filter rod 22 includes a single segment, but is limited thereto. In other words, the filter rod 22 may include a plurality of segments. For example, the filter rod 22 may include a first segment configured to cool an aerosol and a second segment configured to filter a certain component included in the aerosol. Also, as necessary, the filter rod 22 may further include at least one segment configured to perform other functions.

The diameter of the aerosol generating article 2 is within the range of 5 mm to 9 mm, and the length may be about 48 mm, but is not limited thereto. For example, the length of the tobacco rod 21 may be about 12 mm, the length of the first segment of the filter rod 22 may be about 10 mm, the length of the second segment of the filter rod 22 may be about 14 mm, and the length of the third segment of the filter rod 22 may be about 12 mm. However, disclosure is not limited thereto.

The aerosol generating article 2 may be packaged by at least one wrapper 24. The wrapper 24 may have at least one hole through which external air may be introduced or internal air may be discharged. For example, the aerosol generating article 2 may be packaged by one wrapper 24. As another example, the aerosol generating article 2 may be doubly packaged by at least two wrappers 24. For example, the tobacco rod 21 may be packaged by a first wrapper 241, and the filter rod 22 may be packaged by wrappers 242, 243, and 244. Also, the entire aerosol generating article 2 may be re-packaged by a single wrapper 245. When the filter rod 22 includes a plurality of segments, each segment may be packaged by the wrappers 242, 243, and 244.

The first wrapper 241 and the second wrapper 242 may be formed of general filter wrapping paper. For example, the first wrapper 241 and the second wrapper 242 may be porous wrapping paper or non-porous wrapping paper. Also, the first wrapper 241 and the second wrapper 242 may be made of an oil-resistant paper sheet and/or an aluminum laminate packaging material.

The third wrapper 243 may be made of hard wrapping paper. For example, a basis weight of the third wrapper 243 may be within a range of 88 g/m² to 96 g/m². For example, the basis weight of the third wrapper 243 may be within a range of 90 g/m² to 94 g/m². Also, a thickness of the third wrapper 243 may be within a range of 120 μm to 130 μm. For example, the thickness of the third wrapper 243 may be 125 μm.

The fourth wrapper 244 may be made of oil-resistant hard wrapping paper. For example, a basis weight of the fourth wrapper 244 may be within a range of about 88 g/m² to about 96 g/m². For example, the basis weight of the fourth wrapper 244 may be within a range of 90 g/m² to 94 g/m². Also, a thickness of the fourth wrapper 244 may be within a range of 120 μm to 130 μm. For example, the thickness of the fourth wrapper 244 may be 125 μm.

The fifth wrapper 245 may be made of sterilized paper (MFW). Here, the MFW refers to paper specially manufactured to have enhanced tensile strength, water resistance, smoothness, and the like, compared to ordinary paper. For example, a basis weight of the fifth wrapper 245 may be within a range of 57 g/m² to 63 g/m². For example, the basis weight of the fifth wrapper 245 may be about 60 g/m². Also, a thickness of the fifth wrapper 245 may be within a range of 64 μm to 70 μm. For example, the thickness of the fifth wrapper 245 may be 67 μm.

A predetermined material may be included in the fifth wrapper 245. Here, an example of the predetermined material may be, but is not limited to, silicon. For example, silicon exhibits characteristics like heat resistance with little change due to the temperature, oxidation resistance, resistances to various chemicals, water repellency, electrical insulation, etc. However, any material other than silicon may be applied to (or coated on) the fifth wrapper 245 without limitation as long as the material has the above-mentioned characteristics.

The fifth wrapper 245 may prevent the aerosol generating article 2 from being burned. For example, when the tobacco rod 21 is heated by the heater, there is a possibility that the aerosol-generating article 2 combusts. In detail, when the temperature is raised to a temperature above the ignition point of any one of materials included in the tobacco rod 21, the aerosol generating article 2 may be burned. Even in this case, since the fifth wrapper 245 includes a non-combustible material, the burning of the aerosol generating article 2 may be prevented.

In addition, the fifth wrapper 245 may prevent the aerosol generating device 1 from being contaminated by substances generated in the aerosol generating article 2. By a user's puff, liquid substances may be generated in the aerosol generating article 2. For example, as an aerosol generated in the aerosol generating article 2 is cooled by the outside air, liquid substances (e.g., moisture, etc.) may be generated. As the fifth wrapper 245 wraps the aerosol generating article 2, the liquid substances generated in the aerosol generating article 2 may be prevented from leaking out of the aerosol generating article 2.

The tobacco rod 21 may include an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod 21 may include other additives, such as flavors, a wetting agent, and/or organic acid. Also, the tobacco rod 21 may include a flavored liquid, such as menthol or a moisturizer, which is injected to the tobacco rod 21.

The tobacco rod 21 may be manufactured in various forms. For example, the tobacco rod 21 may be formed as a sheet or a strand. Also, the tobacco rod 21 may be formed as a pipe tobacco, which is formed of tiny bits cut from a tobacco sheet. Also, the tobacco rod 21 may be surrounded by a heat-conducting material. For example, the heat-conducting material may be, but is not limited to, metal foil such as aluminum foil. For example, the heat-conducting material surrounding the tobacco rod 21 may uniformly distribute heat transmitted to the tobacco rod 21, and thus, the heat conductivity applied to the tobacco rod may be increased and taste of the tobacco may be improved. Also, the heat-conducting material surrounding the tobacco rod 21 can function as a susceptor that is heated by an induction heater. At this time, although not shown in the drawing, the tobacco rod 21 may further include an additional susceptor in addition to the heat-conducting material surrounding the outside.

The filter rod 22 may include a cellulose acetate filter. Shapes of the filter rod 22 are not limited. For example, the filter rod 22 may include a cylinder-type rod or a tube-type rod having a hollow inside. Also, the filter rod 22 may include a recess-type rod. When the filter rod 22 includes a plurality of segments, at least one of the plurality of segments may have a different shape.

The first segment of the filter rod 22 may be a cellulous acetate filter. For example, the first segment may be a tube-type structure having a hollow inside. When the heater is inserted through the first segment, the internal material of the tobacco rod 21 can be prevented from being pushed back, and the cooling effect of the aerosol can also be generated. A diameter of the hollow included in the first segment may be an appropriate diameter within a range of 2 mm to 4.5 mm but is not limited thereto.

The length of the first segment may be an appropriate length within a range of 4 mm to 30 mm but is not limited thereto. For example, the length of the first segment may be 10 mm, but is not limited thereto.

The hardness of the first segment may be adjusted by adjusting the content of the plasticizer during manufacture of the first segment. In addition, the first segment may be manufactured by inserting a structure such as a film or a tube made of the same or different material into the inside (e.g., hollow).

The second segment of the filter rod (22) cools the aerosol generated by the heater heating the tobacco rod (21). Therefore, the user can inhale the aerosol cooled to an appropriate temperature.

The length or diameter of the second segment may be variously determined according to the shape of the aerosol generating article 2. For example, the length of the second segment may be an appropriate length within a range of 7 mm to 20 mm. Preferably, the length of the second segment may be about 14 mm but is not limited thereto.

The second segment may be manufactured by weaving a polymer fiber. In this case, a flavoring liquid may also be applied to the fiber formed of the polymer. Alternatively, the second segment may be manufactured by weaving together an additional fiber coated with a flavoring liquid and a fiber formed of a polymer. Alternatively, the second segment may be formed by a crimped polymer sheet.

For example, a polymer may be formed of a material selected from the group consisting of polyethylene (PE), polypropylene (PP), polyvinyl chloride (PVC), polyethylene terephthalate (PET), polylactic acid (PLA), cellulose acetate (CA), and aluminum foil.

As the second segment is formed by the woven polymer fiber or the crimped polymer sheet, the second segment may include a single channel or a plurality of channels extending in a longitudinal direction. Here, a channel refers to a passage through which a gas (e.g., air or aerosol) passes.

For example, the second segment formed of the crimped polymer sheet may be formed from a material having a thickness between about 5 μm and about 300 μm, for example, between about 10 μm and about 250 μm. Also, a total surface area of the second segment may be between about 300 mm²/mm and about 1000 mm²/mm. In addition, an aerosol cooling element may be formed from a material having a specific surface area between about 10 mm²/mg and about 100 mm²/mg.

The second segment may include a thread including a volatile flavor component. Here, the volatile flavor component may be menthol but is not limited thereto. For example, the thread may be filled with a sufficient amount of menthol to provide the second segment with menthol of 1.5 mg or more.

The third segment of the filter rod 22 may be a cellulose acetate filter. The length of the third segment may be an appropriate length within a range of 4 mm to 20 mm. For example, the length of the third segment may be about 12 mm but is not limited thereto.

The third segment may be fabricated such that flavor is generated by spraying a flavored liquid on the third segment in the process of fabricating the third segment. Alternatively, a separate fiber coated with flavoring liquid may be inserted into the third segment. The aerosol generated in the tobacco rod 21 is cooled as it passes through the second segment of the filter rod 22, and the cooled aerosol is delivered to the user through the third segment. Therefore, when the flavoring element is added to the third segment, the effect of enhancing the persistence of the flavor delivered to the user may occur.

Also, the filter rod 22 may include at least one capsule 23. Here, the capsule 23 may generate a flavor or an aerosol. For example, the capsule 23 may have a configuration in which a liquid including a flavoring material is wrapped with a film. The capsule 23 may have a spherical or cylindrical shape, but is not limited thereto.

Referring to FIG. 12, an aerosol generating article 3 may further include a front-end plug 33. The front-end plug 33 may be located on a side of a tobacco rod 31, the side facing a filter rod 32. The front-end plug 33 may prevent the tobacco rod 31 from being detached and prevent a liquefied aerosol from flowing into the aerosol generating device 1 from the tobacco rod 31, during smoking.

The filter rod 32 may include a first segment 321 and a second segment 322. Here, the first segment 321 may correspond to the first segment of the filter rod 22 of FIG. 11, and the second segment 322 may correspond to the third segment of the filter rod 22 of FIG. 11.

A diameter and a total length of the aerosol generating article 3 may correspond to the diameter and the total length of the aerosol generating article 2 of FIG. 11. For example, a length of the front-end plug 33 may be about 7 mm, a length of the tobacco rod 31 may be about 15 mm, a length of the first segment 321 may be about 12 mm, and a length of the second segment 322 may be about 14 mm, but embodiments are not limited thereto.

The aerosol generating article 3 may be wrapped by at least one wrapper 35. The wrapper 35 may have at least one hole through which external air may be introduced or internal air may be discharged. For example, the front-end plug 33 may be wrapped using a first wrapper 351, the tobacco rod 31 may be wrapped using a second wrapper 352, the first segment 321 may be wrapped using a third wrapper 353, and the second segment 322 may be wrapped using a fourth wrapper 354. Also, the entire aerosol generating article 3 may be re-wrapped using a fifth wrapper 355.

In addition, the fifth wrapper 355 may have at least one perforation 36 formed therein. For example, the perforation 36 may be formed in an area of the fifth wrapper 355 surrounding the tobacco rod 31 but is not limited thereto. the perforation 36 may serve to transfer heat generated by the heater to the inside of the tobacco rod 31.

Also, the second segment 322 may include at least one capsule 34. Here, the capsule 34 may generate a flavor or an aerosol. For example, the capsule 34 may have a configuration in which a liquid including a flavoring material is wrapped with a film. The capsule 34 may have a spherical or cylindrical shape but is not limited thereto.

The first wrapper 351 may be formed by combining general filter wrapping paper with metal foil such as aluminum foil. For example, the total thickness of the first wrapper 351 may be within a range of 45 μm to 55 μm. For example, the total thickness of the first wrapper 351 may be 50.3 μm. Also, a thickness of the metal foil of the first wrapper 351 may be within a range 6 μm to 7 μm. For example, the thickness of the metal foil of the first wrapper 351 may be 6.3 μm. In addition, a basis weight of the first wrapper 351 may be within a range of 50 g/m² to 55 g/m². For example, the basis weight of the first wrapper 351 may be 53 g/m².

The second wrapper 352 and the third wrapper 353 may be formed of general filter wrapping paper. For example, the second wrapper 352 and the third wrapper 353 may be porous wrapping paper or non-porous wrapping paper.

For example, porosity of the second wrapper 352 may be 35000 CU but is not limited thereto. Also, a thickness of the second wrapper 352 may be within a range of 70 μm to 80 μm. For example, the thickness of the second wrapper 352 may be 78 μm. A basis weight of the second wrapper 352 may be within a range of 20 g/m² to 25 g/m². For example, the basis weight of the second wrapper 352 may be 23.5 g/m².

For example, porosity of the third wrapper 353 may be 24000 CU but is not limited thereto. Also, a thickness of the third wrapper 353 may be in a range of about 60 μm to about 70 μm. For example, the thickness of the third wrapper 353 may be 68 μm. A basis weight of the third wrapper 353 may be in a range of about 20 g/m² to about 25 g/m². For example, the basis weight of the third wrapper 353 may be 21 g/m².

The fourth wrapper 354 may be formed of PLA laminated paper. Here, the PLA laminated paper refers to three-layer paper including a paper layer, a PLA layer, and a paper layer. For example, a thickness of the fourth wrapper 354 may be in a range of 100 μm to 120 μm. For example, the thickness of the fourth wrapper 354 may be 110 μm. Also, a basis weight of the fourth wrapper 354 may be in a range of 80 g/m² to 100 g/m². For example, the basis weight of the fourth wrapper 354 may be 88 g/m².

The fifth wrapper 355 may be formed of MFW. Here, the MFW refers to paper which is particularly manufactured to improve tensile strength, water resistance, smoothness, and the like more than ordinary paper. For example, a basis weight of the fifth wrapper 355 may be in a range of 57 g/m² to 63 g/m². For example, the basis weight of the fifth wrapper 355 may be 60 g/m². Also, a thickness of the fifth wrapper 355 may be in a range of 64 μm to 70 μm. For example, the thickness of the fifth wrapper 355 may be 67 μm.

The fifth wrapper 355 may include a preset material added thereto. An example of the material may include silicon, but it is not limited thereto. Silicon has characteristics such as heat resistance robust to temperature conditions, oxidation resistance, resistance to various chemicals, water repellency to water, and electrical insulation, etc. Besides silicon, any other materials having characteristics as described above may be applied to (or coated on) the fifth wrapper 355 without limitation.

The front-end plug 33 may be formed of cellulose acetate. For example, the front-end plug 33 may be formed by adding a plasticizer (e.g., triacetin) to cellulous acetate tow. Mono-denier of filaments constituting the cellulous acetate tow may be in a range of 1.0 to 10.0. For example, the mono-denier of filaments constituting the cellulous acetate tow may be within a range of 4.0 to 6.0. For example, the mono-denier of the filaments of the front-end plug 33 may be 5.0. Also, a cross-section of the filaments constituting the front-end plug 33 may be a Υ shape. Total denier of the front-end plug 33 may be in a range of 20000 to 30000. For example, the total denier of the front-end plug 33 may be within a range of 25000 to 30000. For example, the total denier of the front-end plug 33 may be 28000.

Also, as needed, the front-end plug 33 may include at least one channel. A cross-sectional shape of the channel may be manufactured in various shapes.

The tobacco rod 31 may correspond to the tobacco rod 21 described above with reference to FIG. 11. Therefore, hereinafter, the detailed description of the tobacco rod 31 will be omitted.

The first segment 321 may be formed of cellulous acetate. For example, the first segment 321 may be a tube-type structure having a hollow inside. The first segment 321 may be manufactured by adding a plasticizer (e.g., triacetin) to cellulous acetate tow. For example, mono-denier and total denier of the first segment 321 may be the same as the mono-denier and total denier of the front-end plug 33.

The second segment 322 may be formed of cellulous acetate. Mono denier of filaments constituting the second segment 322 may be in a range of 1.0 to 10.0. For example, the mono denier of the filaments of the second segment 322 may be within a range of about 8.0 to about 10.0. For example, the mono denier of the filaments of the second segment 322 may be 9.0. Also, a cross-section of the filaments of the second segment 322 may be a Υ shape. Total denier of the second segment 322 may be in a range of 20000 to 30000. For example, the total denier of the second segment 322 may be 25000.

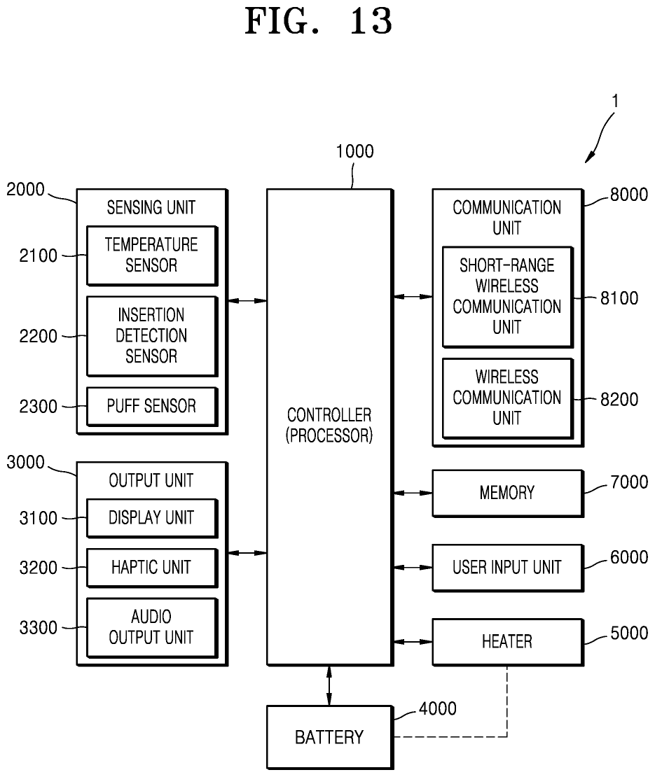

FIG. 13 is a block diagram of an aerosol generating device according to another embodiment.

The aerosol generating device 1 may include a controller 1000, a sensing unit 2000, an output unit 3000, a battery 4000, a heater 5000, a user input unit 6000, a memory 7000, and a communication unit 8000. However, the internal structure of the aerosol generating device 1 is not limited to those illustrated in FIG. 13. That is, according to the design of the aerosol generating device 1, it will be understood by one of ordinary skill in the art that some of the components shown in FIG. 13 may be omitted or new components may be added.

The sensing unit 2000 may sense a state of the aerosol generating device 1 and a state around the aerosol generating device 1, and transmit sensed information to the controller 1000. Based on the sensed information, the controller 1000 may control the aerosol generating device 1 to perform various functions, such as controlling an operation of the heater 5000, limiting smoking, determining whether an aerosol generating article (e.g., a cigarette, a cartridge, or the like) is inserted, displaying a notification, or the like.

The sensing unit 2000 may include at least one of a temperature sensor 2100, an insertion detection sensor 2200, and a puff sensor 2300, but is not limited thereto.

The temperature sensor 2100 may sense a temperature at which the heater 5000 (or an aerosol generating material) is heated. The aerosol generating device 1 may include a separate temperature sensor for sensing the temperature of the heater 5000, or the heater 5000 may serve as a temperature sensor. Alternatively, the temperature sensor 2100 may also be arranged around the battery 4000 to monitor the temperature of the battery 4000.

The insertion detection sensor 2200 may sense insertion and/or removal of an aerosol generating article. For example, the insertion detection sensor 2200 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 2300 may sense a user's puff on the basis of various physical changes in an airflow passage or an airflow channel. For example, the puff sensor 2300 may sense a user's puff on the basis of any one of a temperature change, a flow change, a voltage change, and a pressure change.

The sensing unit 2000 may include, in addition to the temperature sensor 2100, the insertion detection sensor 2200, and the puff sensor 2300 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 3000 may output information on a state of the aerosol generating device 1 and provide the information to a user. The output unit 3000 may include at least one of a display unit 3100, a haptic unit 3200, and a sound output unit 3300, but is not limited thereto. When the display unit 3100 and a touch pad form a layered structure to form a touch screen, the display unit 3100 may also be used as an input device in addition to an output device.

The display unit 3100 may visually provide information about the aerosol generating device 1 to the user. For example, information about the aerosol generating device 1 may mean various pieces of information, such as a charging/discharging state of the battery 4000 of the aerosol generating device 1, a preheating state of the heater 5000, an insertion/removal state of an aerosol generating article, or a state in which the use of the aerosol generating device 1 is restricted (e.g., sensing of an abnormal object), or the like, and the display unit 3100 may output the information to the outside. The display unit 3100 may be, for example, a liquid crystal display panel (LCD), an organic light-emitting diode (OLED) display panel, or the like. In addition, the display unit 3100 may be in the form of a light-emitting diode (LED) light-emitting device.

The haptic unit 3200 may tactilely provide information about the aerosol generating device 1 to the user by converting an electrical signal into a mechanical stimulus or an electrical stimulus. For example, the haptic unit 3200 may include a motor, a piezoelectric element, or an electrical stimulation device.

The sound output unit 3300 may audibly provide information about the aerosol generating device 1 to the user. For example, the sound output unit 3300 may convert an electrical signal into a sound signal and output the same to the outside.

The battery 4000 may supply power used to operate the aerosol generating device 1. The battery 4000 may supply power such that the heater 5000 may be heated. In addition, the battery 4000 may supply power required for operations of other components (e.g., the sensing unit 2000, the output unit 3000, the user input unit 6000, the memory 7000, and the communication unit 8000) in the aerosol generating device 1. The battery 4000 may be a rechargeable battery or a disposable battery. For example, the battery 4000 may be a lithium polymer (LiPoly) battery, but is not limited thereto.

The heater 5000 may receive power from the battery 4000 to heat an aerosol generating material. Although not illustrated in FIG. 13, the aerosol generating device 1 may further include a power conversion circuit (e.g., a direct current (DC)/DC converter) that converts power of the battery 4000 and supplies the same to the heater 5000. In addition, when the aerosol generating device 1 generates aerosols in an induction heating method, the aerosol generating device 1 may further include a DC/alternating current (AC) that converts DC power of the battery 4000 into AC power.

The controller 1000, the sensing unit 2000, the output unit 3000, the user input unit 6000, the memory 7000, and the communication unit 8000 may each receive power from the battery 4000 to perform a function. Although not illustrated in FIG. 13, the aerosol generating device 1 may further include a power conversion circuit that converts power of the battery 4000 to supply the power to respective components, for example, a low dropout (LDO) circuit, or a voltage regulator circuit.

In an embodiment, the heater 5000 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 5000 may be implemented by a metal wire, a metal plate on which an electrically conductive track is arranged, a ceramic heating element, or the like, but is not limited thereto.

In another embodiment, the heater 5000 may be a heater of an induction heating type. For example, the heater 5000 may include a suspector that heats an aerosol generating material by generating heat through a magnetic field applied by a coil.

The user input unit 6000 may receive information input from the user or may output information to the user. For example, the user input unit 6000 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 13, the aerosol generating device 1 may further include a connection interface, such as a universal serial bus (USB) interface, and may connect to other external devices through the connection interface, such as the USB interface, to transmit and receive information, or to charge the battery 4000.

The memory 7000 is a hardware component that stores various types of data processed in the aerosol generating device 1, and may store data processed and data to be processed by the controller 1000. The memory 7000 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 7000 may store an operation time of the aerosol generating device 1, the maximum number of puffs, the current number of puffs, at least one temperature profile, data on a user's smoking pattern, etc.

The communication unit 8000 may include at least one component for communication with another electronic device. For example, the communication unit 8000 may include a short-range wireless communication unit 8100 and a wireless communication unit 8200.

The short-range wireless communication unit 8100 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 8200 may include a cellular network communication unit, an Internet communication unit, a computer network (e.g., local area network (LAN) or wide area network (WAN)) communication unit, or the like, but is not limited thereto. The wireless communication unit 8200 may also identify and authenticate the aerosol generating device 1 within a communication network by using subscriber information (e.g., International Mobile Subscriber Identifier (IMSI)).

The controller 1000 may control general operations of the aerosol generating device 1. In an embodiment, the controller 1000 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

The controller 1000 may control the temperature of the heater 5000 by controlling supply of power of the battery 4000 to the heater 5000. For example, the controller 1000 may control power supply by controlling switching of a switching element between the battery 4000 and the heater 5000. In another example, a direct heating circuit may also control power supply to the heater 5000 according to a control command of the controller 1000.

The controller 1000 may analyze a result sensed by the sensing unit 2000 and control subsequent processes to be performed. For example, the controller 1000 may control power supplied to the heater 5000 to start or end an operation of the heater 5000 on the basis of a result sensed by the sensing unit 2000. As another example, the controller 1000 may control, based on a result sensed by the sensing unit 2000, an amount of power supplied to the heater 5000 and the time the power is supplied, such that the heater 5000 may be heated to a certain temperature or maintained at an appropriate temperature.

The controller 1000 may control the output unit 3000 on the basis of a result sensed by the sensing unit 2000. For example, when the number of puffs counted through the puff sensor 2300 reaches a preset number, the controller 1000 may notify the user that the aerosol generating device 1 will soon be terminated through at least one of the display unit 3100, the haptic unit 3200, and the sound output unit 3300.

One embodiment may also be implemented in the form of a computer-readable recording medium including instructions executable by a computer, such as a program module executable by the computer. The computer-readable recording medium may be any available medium that may be accessed by a computer and includes both volatile and nonvolatile media, and removable and non-removable media. In addition, the computer-readable recording medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium typically includes computer-readable instructions, data structures, other data in modulated data signals such as program modules, or other transmission mechanisms, and includes any information transfer media.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

A heater assembly for an aerosol generating device and an aerosol generating device according to various embodiments may be miniaturized by improving space utilization in which components are located and may have a compact structure while accommodating various components.

Also, a heater assembly for an aerosol generating device and an aerosol generating device according to various embodiments may allow a user to easily inhale aerosol by facilitating the flow of air in an air flow passage.

The effects of the embodiments are not limited to the aforementioned description, and other effects may be clearly understood by one of ordinary skill in the art from the embodiments to be described hereinafter.

What is claimed is:

1. A heater assembly for an aerosol generating device, comprising:
a body comprising a receiving space in which an aerosol generating article is accommodated;
a coil configured to apply a magnetic field so that a susceptor located in the receiving space generates heat to heat the aerosol generating article;
an air flow passage cover located outside the body and comprising an air flow passage through which air passes;
a pressure sensor located on the air flow passage cover and configured to detect a change in pressure inside the air flow passage; and
a moisture detecting sensor located on a support unit for supporting the coil and configured to detect moisture in the aerosol generating article accommodated in the receiving space.

2. The heater assembly for an aerosol generating device of claim 1, further comprising an article detecting sensor located on the air flow passage cover at a position spaced apart from the pressure sensor and configured to detect a type of the aerosol generating article accommodated in the receiving space.

3. The heater assembly for an aerosol generating device of claim 2, wherein the air flow passage cover comprises a sensor receiver in which at least one of the pressure sensor or the article detecting sensor is accommodated.

4. The heater assembly for an aerosol generating device of claim 2, wherein the pressure sensor and the article detecting sensor are mounted together on one mount member located on the air flow passage cover.

5. The heater assembly for an aerosol generating device of claim 1, further comprising a sensor protective cover coupled to the air flow passage cover to cover at least a part of the pressure sensor.

6. The heater assembly for an aerosol generating device of claim 1, wherein an air inlet through which air is introduced is formed in the air flow passage cover,
wherein the air inlet is spaced apart from a portion through which the aerosol generating article is inserted.

7. The heater assembly for an aerosol generating device of claim 1, wherein the air flow passage communicates with the receiving space,
wherein at least part of air moving through the air flow passage passes through the aerosol generating article accommodated in the receiving space and is discharged to an outside.

8. The heater assembly for an aerosol generating device of claim 1, wherein the moisture detecting sensor is located to correspond to one segment of the aerosol generating article comprising an aerosol generating material.

9. The heater assembly for an aerosol generating device of claim 1, wherein at least a part of the moisture detecting sensor comprises a curved surface.

10. The heater assembly for an aerosol generating device of claim 1, further comprising a sensor bracket located outside the support unit,
wherein the moisture detecting sensor is coupled to the sensor bracket and coupled to the support unit.

11. The heater assembly for an aerosol generating device of claim 1, further comprising a first cover coupled to the body and comprising an article insertion portion into which the aerosol generating article is inserted.

12. The heater assembly for an aerosol generating device of claim 11, wherein the first cover comprises a cover insulation member extending along a direction in which the coil extends and located between the coil and the body.

13. The heater assembly for an aerosol generating device of claim 11, further comprising a temperature detecting unit located inside the body and configured to detect a temperature of the coil,
wherein the first cover further comprises an avoidance groove into which the temperature detecting unit is inserted.

14. The heater assembly for an aerosol generating device of claim 11, further comprising a holder coupled to the first cover and comprising an insertion hole and a ridge, wherein the insertion hole communicates with the article insertion portion so that the aerosol generating article is accommodated in the receiving space, and the ridge protrudes toward the insertion hole to support the aerosol generating article.

15. An aerosol generating device comprising:
the heater assembly for an aerosol generating device of claim 1;
a battery configured to supply power to the heater assembly for an aerosol generating device; and
a controller configured to control an operation of the heater assembly for an aerosol generating device.
